(19) United States
(12) Patent Application Publication
(10) Pub. No.: US 2024/0303114 A1
(43) Pub. Date: Sep. 12, 2024

(54) DYNAMIC ALLOCATION OF CAPACITY TO NAMESPACES IN A DATA STORAGE DEVICE

(71) Applicant: Western Digital Technologies, Inc., San Jose, CA (US)

(72) Inventors: Sridhar Sabesan, Bangalore (IN); Dinesh Babu, Bangalore (IN); Pavan Gururaj, Bangalore (IN)

(21) Appl. No.: 18/355,753

(22) Filed: Jul. 20, 2023

Related U.S. Application Data
(60) Provisional application No. 63/489,569, filed on Mar. 10, 2023.

(51) Int. Cl. G06F 9/50

(52) U.S. Cl. CPC G06F 9/5016; G06F 9/5033

(57) ABSTRACT

Systems, methods, and data storage devices for dynamic allocation of capacity to namespaces are described. A data storage device may support multiple host connections to multiple namespaces allocated in its non-volatile storage medium according to a storage protocol, such as non-volatile memory express (NVMe). Each namespace may initially be allocated with an allocated capacity. For at least some of the namespaces, a portion of the allocated capacity may be allocated to a floating namespace pool. When the fill mark for one of the namespaces reaches a flexible capacity threshold, capacity from the floating namespace pool may be dynamically allocated to that namespace and removed from the floating namespace pool.

### TECHNICAL FIELD

The present disclosure generally relates to capacity allocation in data storage devices and, more particularly, to dynamic allocation of storage resources across defined host namespaces in the same data storage device.

### BACKGROUND

Multi-device storage systems utilize multiple discrete data storage devices, generally disk drives (solid-state drives (SSD), hard disk drives (HDD), hybrid drives, tape drives, etc.) for storing large quantities of data. These multi-device storage systems are generally arranged in an array of drives interconnected by a common communication fabric and, in many cases, controlled by a storage controller, redundant array of independent disks (RAID) controller, or general controller, for coordinating storage and system activities across the array of drives. The data stored in the array may be stored according to a defined RAID level, a combination of RAID schemas, or other configurations for providing desired data redundancy, performance, and capacity utilization. In general, these data storage configurations may involve some combination of redundant copies (mirroring), data striping, and/or parity (calculation and storage), and may incorporate other data management, error correction, and data recovery processes, sometimes specific to the type of disk drives being used (e.g., solid-state drives versus hard disk drives).

To support the faster speeds and low latencies needed for many distributed applications, direct memory access storage protocols, such as non-volatile memory express (NVMe), have become important in storage system deployment. NVMe enables fast access to non-volatile memory devices connected to servers through peripheral component interconnect express (PCIe) buses. Namespaces and corresponding logical host connections may be used to manage access between host applications and the host data stored in the attached namespaces of the data storage devices. In some configurations, NVMe-over-Fabric (NVMeoF) enables servers to share NVMe flash storage as if it were local memory within the host system's file system.

With growing storage demands and the cost of storage, storage arrays, such as storage area networks (SANs), may be thinly provisioned and use administrator notifications when they run out of space. In thinly provisioned deployments, the goal may be to add capacity (in the form of additional data storage devices) only as it is needed. Most disk drives, such as SSDs, have a fixed capacity and it is not possible to add capacity to the data storage device after it is deployed. Similarly, namespaces are generally allocated in the disk drives in fixed capacity blocks. In thinly provisioned systems, underutilized namespaces within individual data storage devices may represent significant wasted capacity that may cause new devices to be added despite available capacity in one or more allocated but underutilized namespaces.

Uneven namespace utilization may be created by a number of factors, typically driven by the corresponding host applications and operational demands. Some namespaces may simply be associated with applications that generate more or less data and, therefore, require different amounts of storage space. Some namespaces may support write intensive applications, while other may be read intensive. Some namespaces may have higher performance requirements, which may impact resource availability for garbage collection and other processes for managing and reclaiming previously used capacity, as well as drive the sheer volume of data being stored or accessed. As a result, some namespaces may be fast filling, while other namespaces may be slower filling. The net result may be capacity starvation for some namespaces and unused capacity for other namespaces.

Under NVMe storage protocols, namespaces have a fixed capacity when created and attached to a host. The host system may, in turn, map the fixed capacity namespaces to available capacity in its file system. The storage system may not have the capability to reallocate capacity within existing data storage devices and corresponding namespaces as, in thin provisioned systems, all capacity in each added data storage device may be allocated to specific namespaces, non-volatile memory (NVM) sets, and/or endurance groups.

Therefore, there still exists a need for storage systems with flexible and dynamic allocation of non-volatile memory capacity among namespaces within thinly provisioned data storage devices that can adapt to the varying usage of those namespaces.

### SUMMARY

Various aspects for dynamic allocation of capacity to namespaces in a data storage device are described. More particularly, a flexible capacity portion of each namespace may be allocated to a floating namespace pool and used to increase the capacity of namespaces that need it. This may enable namespaces with higher utilization to borrow capacity from underutilized namespaces to reduce wasted capacity in a thin provisioned system.

One general aspect includes a system that includes a data storage device including: a non-volatile storage medium configured to store host data for at least one host system, and a host interface configured to communicate with the at least one host system using a storage protocol. The system also includes a namespace manager configured to: determine a plurality of host connections to a plurality of namespaces in the non-volatile storage medium, where each namespace of the plurality of namespaces has a first allocated capacity and at least one namespace of the plurality of namespaces allocates a portion of the first allocated capacity to a floating namespace pool; determine, for a target namespace of the plurality of namespaces, whether a filled mark of the target namespace meets a flexible capacity threshold for the target namespace; and allocate, responsive to the filled mark meeting the flexible capacity threshold, a capacity unit from the floating namespace pool to the target namespace to increase the first allocated capacity to a second allocated capacity.

Implementations may include one or more of the following features. The first allocated capacity of each namespace of the plurality of namespaces may include a guaranteed capacity value and a flexible capacity value; and a sum of initial values for the guaranteed capacity value and the flexible capacity value may equal the first allocated capacity. The namespace manager may be further configured to: receive a request for a new namespace in the plurality of namespaces; determine, based on the first allocated capacity, a default guaranteed capacity allocation and a default flexible capacity allocation; and selectively determine, based on the default guaranteed capacity allocation and the default flexible capacity allocation, the initial values for the guaranteed capacity value and the flexible capacity value of the new namespace. The namespace manager may be further configured to: receive a request for a new namespace in the plurality of namespaces; determine, from a custom guaranteed capacity attribute in the request, a custom guaranteed capacity allocation and a custom flexible capacity allocation; and selectively determine, based on the custom guaranteed capacity allocation and the custom flexible capacity allocation, the initial values for the guaranteed capacity value and the flexible capacity value of the new namespace. The namespace manager may be further configured to: receive a request for a new namespace in the plurality of namespaces; determine, from the request, a flexible capacity flag; and selectively determine, based on the flexible capacity flag and for the new namespace, the guaranteed capacity value equals the first allocated capacity and the flexible capacity value equals zero. The namespace manager may be further configured to: determine, for each namespace of the plurality of namespaces, whether that namespace is an operating type selected from a fast filling namespace or a slow filling namespace; and determine, based on the operating type for each namespace of the plurality of namespaces, the initial values for the guaranteed capacity value and the flexible capacity value for that namespace. The namespace manager may be further configured to, responsive to allocating the capacity unit from the floating namespace pool: update the guaranteed capacity value for the target namespace to the filled mark; and update the flexible capacity value for the target namespace to a difference between the second allocated capacity and the updated guaranteed capacity value. The namespace manager may be further configured to: determine an aggregate capacity for the floating namespace pool based on the flexible capacity value of each namespace of the plurality of namespaces; and decrease, responsive to allocating the capacity unit from the floating namespace pool, the aggregate capacity by the capacity unit. The floating namespace pool may include the flexible capacity value of each namespace in the plurality of namespaces and at least one unallocated capacity value from: unallocated space from at least one non-volatile memory set defined using the storage protocol; or unallocated space from at least one endurance group defined using the storage protocol. The system may include at the at least one host system including: a host processor; a host memory; a host file system; a storage interface configured to communicate with the data storage device using the storage protocol; and a storage driver. The storage driver may be configured to: determine, for each namespace of the plurality of namespaces, the first allocated capacity; map, for each namespace of the plurality of namespaces, the first allocated capacity to allocated capacity in the host file system; receive a namespace capacity change notification for the target namespace, where the namespace manager is further configured to send the namespace capacity change notification responsive to allocating the capacity unit from the floating namespace pool; and update the first allocated capacity to the second allocated capacity in the host file system. Implementations of the described techniques may include hardware, a method or process, or computer software on a computer-accessible medium.

Another general aspect includes a computer-implemented method that includes: determining a plurality of host connections to a plurality of namespaces in a non-volatile storage medium of a data storage device, where the plurality of host connections is configured for access from at least one host system to host data in the plurality of namespaces using a storage protocol and each namespace of the plurality of namespaces has a first allocated capacity; allocating, for at least one namespace of the plurality of namespaces, a portion of the first allocated capacity to a floating namespace pool; determining, for a target namespace of the plurality of namespaces, whether a filled mark of the target namespace meets a flexible capacity threshold for the target namespace; and allocating, responsive to the filled mark meeting the flexible capacity threshold, a capacity unit from the floating namespace pool to the target namespace to increase the first allocated capacity to a second allocated capacity.

Implementations may include one or more of the following features. The first allocated capacity of each namespace of the plurality of namespaces may include a guaranteed capacity value and a flexible capacity value; and a sum of initial values for the guaranteed capacity value and the flexible capacity value may equal the first allocated capacity. The computer-implemented method may include: receiving a request for a new namespace in the plurality of namespaces; determining, based on the first allocated capacity, a default guaranteed capacity allocation and a default flexible capacity allocation; and selectively determining, based on the default guaranteed capacity allocation and the default flexible capacity allocation, the initial values for the guaranteed capacity value and the flexible capacity value of the new namespace. The computer-implemented method may include: receiving a request for a new namespace in the plurality of namespaces; determining, from a custom guaranteed capacity attribute in the request, a custom guaranteed capacity allocation and a custom flexible capacity allocation; and selectively determining, based on the custom guaranteed capacity allocation and the custom flexible capacity allocation, the initial values for the guaranteed capacity value and the flexible capacity value of the new namespace. The computer-implemented method may include: receiving a request for a new namespace in the plurality of namespaces; determining, from the request, a flexible capacity flag; and selectively determining, based on the flexible capacity flag and for the new namespace, the guaranteed capacity value equals the first allocated capacity and the flexible capacity value equals zero. The computer-implemented method may include: determining, for each namespace of the plurality of namespaces, whether that namespace is an operating type selected from a fast filling namespace or a slow filling namespace; determining, based on the operating type for each namespace of the plurality of namespaces, the initial values for the guaranteed capacity value and the flexible capacity value for that namespace; and determining, based on the operating type for each namespace of the plurality of namespaces, the flexible capacity threshold for that namespace. The computer-implemented method may include, responsive to allocating the capacity unit from the floating namespace pool: updating the guaranteed capacity value for the target namespace to the filled mark; and updating the flexible capacity value for the target namespace to a difference between the second allocated capacity and the updated guaranteed capacity value. The computer-implemented method may include: determining an aggregate capacity for the floating namespace pool based on the flexible capacity value of each namespace of the plurality of namespaces; and decreasing, responsive to allocating the capacity unit from the floating namespace pool, the aggregate capacity by the capacity unit. The computer-implemented method may include: determining, by the at least one host system and for each namespace of the plurality of namespaces, the first allocated capacity; mapping, for each namespace of the plurality of namespaces, the first allocated capacity to allocated capacity in a host file system of the at least one host system; sending, to the at least one host system, a namespace capacity change notification responsive to allocating the capacity unit from the floating namespace pool; receiving, by the at least one host system, the namespace capacity change notification for the target namespace; and updating, responsive to the namespace capacity change notification, the first allocated capacity to the second allocated capacity in the host file system.

Still another general aspect includes a data storage device that includes: a processor; a memory; a non-volatile storage medium configured to store host data for at least one host system; a host interface configured to communicate with the at least one host system using a storage protocol; means for determining a plurality of host connections to a plurality of namespaces in the non-volatile storage medium, where: the plurality of host connections is configured for access from at least one host system to host data in the plurality of namespaces using a storage protocol; and each namespace of the plurality of namespaces has a first allocated capacity. The device also includes means for allocating, for at least one namespace of the plurality of namespaces, a portion of the first allocated capacity to a floating namespace pool; means for determining, for a target namespace of the plurality of namespaces, whether a filled mark of the target namespace meets a flexible capacity threshold for the target namespace; and means for allocating, responsive to the filled mark meeting the flexible capacity threshold, a capacity unit from the floating namespace pool to the target namespace to increase the first allocated capacity to a second allocated capacity.

The various embodiments advantageously apply the teachings of data storage devices and/or multi-device storage systems to improve the functionality of such computer systems. The various embodiments include operations to overcome or at least reduce the issues previously encountered in storage arrays and/or systems and, accordingly, are more reliable and/or efficient than other computing systems. That is, the various embodiments disclosed herein include hardware and/or software with functionality to improve utilization of non-volatile memory resources in individual data storage devices in a multi-device storage system, such as by using a floating namespace pool to support dynamic reallocation of capacity. Accordingly, the embodiments disclosed herein provide various improvements to storage networks and/or storage systems.

It should be understood that language used in the present disclosure has been principally selected for readability and instructional purposes, and not to limit the scope of the subject matter disclosed herein.

### BRIEF DESCRIPTION OF THE DRAWINGS

FIG. 1 schematically illustrates a multi-device storage system supporting a plurality of host systems.

FIG. 2a schematically illustrates namespaces with different operating characteristics in a data storage device.

FIG. 2b schematically illustrates namespace allocations with contributions to a floating namespace pool.

FIG. 3 schematically illustrates a storage node of the multi-device storage system of FIG. 1.

FIG. 4 schematically illustrates a host node of the multi-device storage system of FIG. 1.

FIG. 5 schematically illustrates some elements of the storage node of FIG. 1-3 in more detail.

FIG. 6 is a flowchart of an example method of setting guaranteed capacity for a new namespace.

FIG. 7 schematically illustrates two example namespaces before and after dynamic reallocation of capacity.

FIG. 8 is a flowchart of an example method of dynamically adjusting namespace capacity.

FIG. 9 is a flowchart of an example method of notifying a host system to update its file system.

FIG. 10 is a flowchart of an example method of determining floating namespace configuration for a namespace.

FIG. 11 is a flowchart of an example method of using capacity from the floating namespace pool to allocate additional capacity to a namespace.

FIG. 12 is a flowchart of an example method of configuring a namespace for use with the floating namespace pool.

FIG. 13 is a flowchart of an example method of managing namespace capacity changes at the host system.

### DETAILED DESCRIPTION

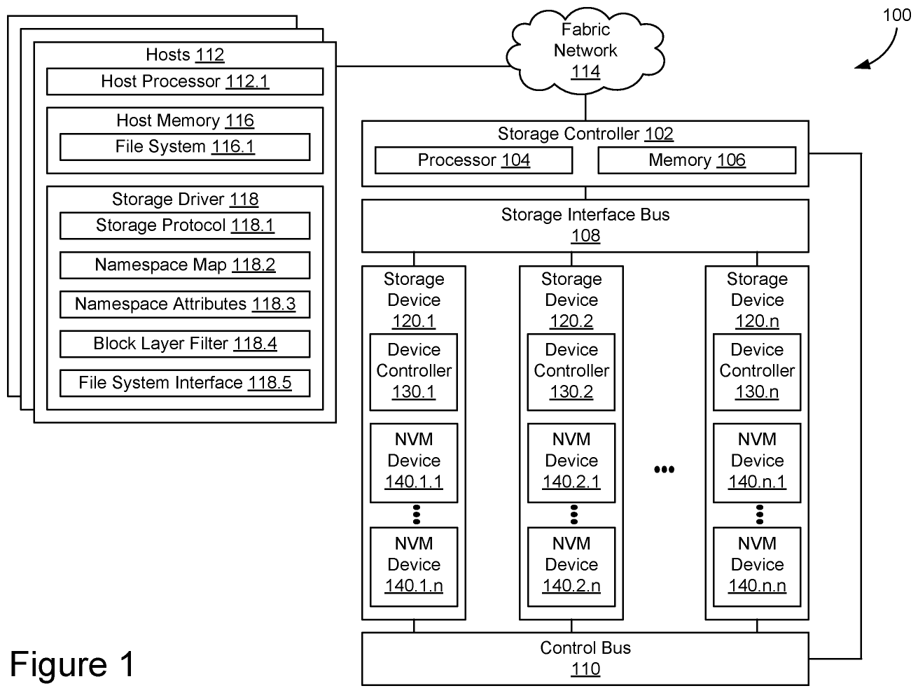

FIG. 1 shows an embodiment of an example data storage system 100 with multiple data storage devices 120 supporting a plurality of host systems 112 through storage controller 102. While some example features are illustrated, various other features have not been illustrated for the sake of brevity and so as not to obscure pertinent aspects of the example embodiments disclosed herein. To that end, as a non-limiting example, data storage system 100 may include one or more data storage devices 120 (also sometimes called information storage devices, storage devices, disk drives, or drives) configured in a storage node with storage controller 102. In some embodiments, storage devices 120 may be configured in a server, storage array blade, all flash array appliance, or similar storage unit for use in data center storage racks or chassis. Storage devices 120 may interface with one or more host nodes or host systems 112 and provide data storage and retrieval capabilities for or through those host systems. In some embodiments, storage devices 120 may be configured in a storage hierarchy that includes storage nodes, storage controllers (such as storage controller 102), and/or other intermediate components between storage devices 120 and host systems 112. For example, each storage controller 102 may be responsible for a corresponding set of storage devices 120 in a storage node and their respective storage devices may be connected through a corresponding backplane network or internal bus architecture including storage interface bus 108 and/or control bus 110, though only one instance of storage controller 102 and corresponding storage node components are shown. In some embodiments, storage controller 102 may include or be configured within a host bus adapter for connecting storage devices 120 to fabric network 114 for communication with host systems 112.

In the embodiment shown, a number of storage devices 120 are attached to a common storage interface bus 108 for host communication through storage controller 102. For example, storage devices 120 may include a number of drives arranged in a storage array, such as storage devices sharing a common rack, unit, or blade in a data center or the SSDs in an all flash array. In some embodiments, storage devices 120 may share a backplane network, network switch(es), and/or other hardware and software components accessed through storage interface bus 108 and/or control bus 110. For example, storage devices 120 may connect to storage interface bus 108 and/or control bus 110 through a plurality of physical port connections that define physical, transport, and other logical channels for establishing communication with the different components and subcomponents for establishing a communication channel to host 112. In some embodiments, storage interface bus 108 may provide the primary host interface for storage device management and host data transfer, and control bus 110 may include limited connectivity to the host for low-level control functions. For example, storage interface bus 108 may support peripheral component interface express (PCIe) connections to each storage device 120 and control bus 110 may use a separate physical connector or extended set of pins for connection to each storage device 120.

In some embodiments, storage devices 120 may be referred to as a peer group or peer storage devices because they are interconnected through storage interface bus 108 and/or control bus 110. In some embodiments, storage devices 120 may be configured for peer communication among storage devices 120 through storage interface bus 108, with or without the assistance of storage controller 102 and/or host systems 112. For example, storage devices 120 may be configured for direct memory access using one or more protocols, such as non-volatile memory express (NVMe), remote direct memory access (RDMA), NVMe over fabric (NVMeOF), etc., to provide command messaging and data transfer between storage devices using the high-bandwidth storage interface and storage interface bus 108.

In some embodiments, data storage devices 120 are, or include, solid-state drives (SSDs). Each data storage device 120.1-120.n may include a non-volatile memory (NVM) or device controller 130 based on compute resources (processor and memory) and a plurality of NVM or media devices 140 for data storage (e.g., one or more NVM device(s), such as one or more flash memory devices). In some embodiments, a respective data storage device 120 of the one or more data storage devices includes one or more NVM controllers, such as flash controllers or channel controllers (e.g., for storage devices having NVM devices in multiple memory channels). In some embodiments, data storage devices 120 may each be packaged in a housing, such as a multi-part sealed housing with a defined form factor and ports and/or connectors for interconnecting with storage interface bus 108 and/or control bus 110.

In some embodiments, a respective data storage device 120 may include a single medium device while in other embodiments the respective data storage device 120 includes a plurality of media devices. In some embodiments, media devices include NAND-type flash memory or NOR-type flash memory. In some embodiments, data storage device 120 may include one or more hard disk drives (HDDs). In some embodiments, data storage devices 120 may include a flash memory device, which in turn includes one or more flash memory die, one or more flash memory packages, one or more flash memory channels or the like. However, in some embodiments, one or more of the data storage devices 120 may have other types of non-volatile data storage media (e.g., phase-change random access memory (PCRAM), resistive random access memory (ReRAM), spin-transfer torque random access memory (STT-RAM), magneto-resistive random access memory (MRAM), etc.).

In some embodiments, each storage device 120 includes a device controller 130, which includes one or more processing units (also sometimes called central processing units (CPUs), processors, microprocessors, or microcontrollers) configured to execute instructions in one or more programs. In some embodiments, the one or more processors are shared by one or more components within, and in some cases, beyond the function of the device controllers. In some embodiments, device controllers 130 may include firmware for controlling data written to and read from media devices 140, one or more storage (or host) interface protocols for communication with other components, as well as various internal functions, such as garbage collection, wear leveling, media scans, and other memory and data maintenance. For example, device controllers 130 may include firmware for running the NVM layer of an NVMe storage protocol alongside media device interface and management functions specific to the storage device. Media devices 140 are coupled to device controllers 130 through connections that typically convey commands in addition to data, and optionally convey metadata, error correction information and/or other information in addition to data values to be stored in media devices and data values read from media devices 140. Media devices 140 may include any number (i.e., one or more) of memory devices including, without limitation, non-volatile semiconductor memory devices, such as flash memory device(s).

In some embodiments, media devices 140 in storage devices 120 are divided into a number of addressable and individually selectable blocks, sometimes called erase blocks. In some embodiments, individually selectable blocks are the minimum size erasable units in a flash memory device. In other words, each block contains the minimum number of memory cells that can be erased simultaneously (i.e., in a single erase operation). Each block is usually further divided into a plurality of pages and/or word lines, where each page or word line is typically an instance of the smallest individually accessible (readable) portion in a block. In some embodiments (e.g., using some types of flash memory), the smallest individually accessible unit of a data set, however, is a sector or codeword, which is a subunit of a page. That is, a block includes a plurality of pages, each page contains a plurality of sectors or codewords, and each sector or codeword is the minimum unit of data for reading data from the flash memory device.

A data unit may describe any size allocation of data, such as host block, data object, sector, page, multi-plane page, erase/programming block, media device/package, etc. Storage locations may include physical and/or logical locations on storage devices 120 and may be described and/or allocated at different levels of granularity depending on the storage medium, storage device/system configuration, and/or context. For example, storage locations may be allocated at a host logical block address (LBA) data unit size and addressability for host read/write purposes but managed as pages with storage device addressing managed in the media flash translation layer (FTL) in other contexts. Media segments may include physical storage locations on storage devices 120, which may also correspond to one or more logical storage locations. In some embodiments, media segments may include a continuous series of physical storage location, such as adjacent data units on a storage medium, and, for flash memory devices, may correspond to one or more media erase or programming blocks. A logical data group may include a plurality of logical data units that may be grouped on a logical basis, regardless of storage location, such as data objects, files, or other logical data constructs composed of multiple host blocks.

In some embodiments, storage controller 102 may be coupled to data storage devices 120 through a network interface that is part of host fabric network 114 and includes storage interface bus 108 as a host fabric interface. In some embodiments, host systems 112 are coupled to data storage system 100 through fabric network 114 and storage controller 102 may include a storage network interface, host bus adapter, or other interface capable of supporting communications with multiple host systems 112. Fabric network 114 may include a wired and/or wireless network (e.g., public and/or private computer networks in any number and/or configuration) which may be coupled in a suitable way for transferring data. For example, the fabric network may include any means of a conventional data communication network such as a local area network (LAN), a wide area network (WAN), a telephone network, such as the public switched telephone network (PSTN), an intranet, the internet, or any other suitable communication network or combination of communication networks. From the perspective of storage devices 120, storage interface bus 108 may be referred to as a host interface bus and provides a host data path between storage devices 120 and host systems 112, through storage controller 102 and/or an alternative interface to fabric network 114.

Host systems 112, or a respective host in a system having multiple hosts, may be any suitable computer device, such as a computer, a computer server, a laptop computer, a tablet device, a netbook, an internet kiosk, a personal digital assistant, a mobile phone, a smart phone, a gaming device, or any other computing device. Host systems 112 are sometimes called a host, client, or client system. In some embodiments, host systems 112 are server systems, such as a server system in a data center. In some embodiments, the one or more host systems 112 are one or more host devices distinct from a storage node housing the plurality of storage devices 120 and/or storage controller 102. In some embodiments, host systems 112 may include a plurality of host systems owned, operated, and/or hosting applications belonging to a plurality of entities and supporting one or more quality of service (QoS) standards for those entities and their applications. Host systems 112 may be configured to store and access data in the plurality of storage devices 120 in a multi-tenant configuration with shared storage resource pools accessed through namespaces and corresponding host connections to those host connections.

Host systems 112 may include one or more central processing units (CPUs) or host processors 112.1 for executing compute operations, storage management operations, and/or instructions for accessing storage devices 120, such as storage commands, through fabric network 114. Host systems 112 may include host memories 116 for storing instructions for execution by host processors 112.1, such as dynamic random access memory (DRAM) devices to provide operating memory for host systems 112. Host memories 116 may include any combination of volatile and non-volatile memory devices for supporting the operations of host systems 112. In some configurations, each host memory 116 may include a host file system 116.1 for managing host data storage to non-volatile memory. Host file system 116.1 may be configured in one or more volumes and corresponding data units, such as files, data blocks, and/or data objects, with known capacities and data sizes. Host file system 116.1 may use at least one storage driver 118 to access storage resources. In some configurations, those storage resources may include both local non-volatile memory devices in host system 112 and host data stored in remote data storage devices, such as storage devices 120, that are accessed using a direct memory access storage protocol, such as NVMe.

Storage driver 118 may be instantiated in the kernel layer of the host operating system for host systems 112. Storage driver 118 may support one or more storage protocols 118.1 for interfacing with data storage devices, such as storage devices 120. Storage driver 118 may rely on one or more interface standards, such as PCIe, ethernet, fibre channel, etc., to provide physical and transport connection through fabric network 114 to storage devices 120 and use a storage protocol over those standard connections to store and access host data stored in storage devices 120. In some configurations, storage protocol 118.1 may be based on defining fixed capacity namespaces on storage devices 120 that are accessed through dynamic host connections that are attached to the host system according to the protocol. For example, host connections may be requested by host systems 112 for accessing a namespace using queue pairs allocated in a host memory buffer and supported by a storage device instantiating that namespace. Storage devices 120 may be configured to support a predefined maximum number of namespaces and a predefined maximum number of host connections. When a namespace is created, it is defined with an initial allocated capacity value and that capacity value is provided to host systems 112 for use in defining the corresponding capacity in file system 116.1. In some configurations, storage driver 118 may include or access a namespace map 118.2 for all of the namespaces available to and/or attached to that host system. Namespace map 118.2 may include entries mapping the connected namespaces, their capacities, and host LBAs to corresponding file system volumes and/or data units. These namespace attributes 118.3 may be used by storage driver 118 to store and access host data on behalf of host systems 112 and may be selectively provided to file system 116.1 through a file system interface 118.5 to manage the block layer storage capacity and its availability for host applications.

Because namespace sizes or capacities are generally regarded as fixed once they are created, a block layer filter 118.4 may be used between the storage device/namespace interface of storage protocol 118.1 and file system interface 118.5 to manage dynamic changes in namespace capacity. Block layer filter 118.4 may be configured to receive a notification from storage devices 120 and/or storage controller 102 and provide the interface to support host file system resizing. Block layer filter 118.4 may be a thin layer residing in the kernel space as a storage driver module. Block layer filter 118.4 may monitor for asynchronous commands from the storage node (using the storage protocol) that include a namespace capacity change notification. Once an async command with the namespace capacity change notification is received by block layer filter 118.4, it may parse a capacity change value and/or an updated namespace capacity value from the notification and generate a resize command to host file system 116.1. Based on the resize command, file system 116.1 may adjust the capacity of the volume mapped to that namespace. Block layer filter 118.4 may also update namespace attributes 118.3 and namespace map 118.2, as appropriate.

Storage controller 102 may include one or more central processing units (CPUs) or processors 104 for executing compute operations, storage management operations, and/or instructions for accessing storage devices 120 through storage interface bus 108. In some embodiments, processors 104 may include a plurality of processor cores which may be assigned or allocated to parallel processing tasks and/or processing threads for different storage operations and/or host storage connections. In some embodiments, processor 104 may be configured to execute fabric interface for communications through fabric network 114 and/or storage interface protocols for communication through storage interface bus 108 and/or control bus 110. In some embodiments, a separate network interface unit and/or storage interface unit (not shown) may provide the network interface protocol and/or storage interface protocol and related processor and memory resources.

Storage controller 102 may include a memory 106 configured to support a plurality of queue pairs allocated between host systems 112 and storage devices 120 to manage command queues and storage queues for host storage operations against host data in storage devices 120. In some embodiments, memory 106 may include one or more DRAM devices for use by storage devices 120 for command, management parameter, and/or host data storage and transfer. In some embodiments, storage devices 120 may be configured for direct memory access (DMA), such as using RDMA protocols, over storage interface bus 108.

In some embodiments, data storage system 100 includes one or more processors, one or more types of memory, a display and/or other user interface components such as a keyboard, a touch screen display, a mouse, a track-pad, and/or any number of supplemental devices to add functionality. In some embodiments, data storage system 100 does not have a display and other user interface components.

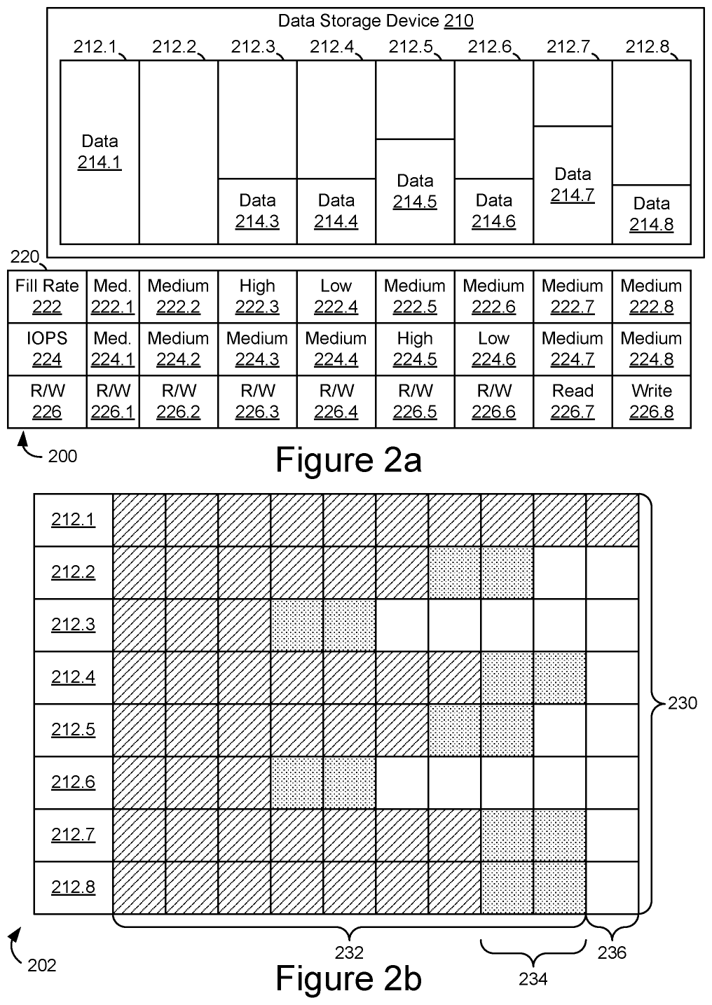

FIGS. 2a and 2b show schematic representations of how the namespaces 212 in an example data storage device 210, such as one of storage devices 120 in FIG. 1, may be used by the corresponding host systems and support dynamic capacity allocation. FIG. 2a shows a snapshot of storage space usage and operating types for namespaces 212. FIG. 2b shows the current capacity allocations for those namespaces, supporting a number of capacity units contributing to a floating namespace pool.

In the example shown, storage device 210 has been allocated across eight namespaces 212.1-212.8 having equal initial capacities. For example, storage device 210 may have a total capacity of 8 terabytes (TB) and each namespace may be created with an initial capacity of 1 TB. Namespace 212.1 may have used all of its allocated capacity, the filled mark for host data 214.1 at 1 TB. Namespace 212.2 may be empty or contain an amount of host data too small to represent in the figure, such as 10 gigabytes (GB). Namespaces 212.3-212.8 are shown with varying levels of corresponding host data 214.3-214.8 stored in memory locations allocated to those namespaces, representing different current filled marks for those namespaces.

Additionally, the use of each namespace may vary on other operating parameters. For example, most of the namespaces may operate with an average or medium fill rate 222, relative to each other and/or system or drive populations generally. However, two namespaces 212.3 and 212.4 may be exhibiting significant variances from the medium range. For example, namespace 212.3 may be exhibiting a high fill rate 222.3 that is over a high fill rate threshold (filling very quickly) and namespace 212.4 may be exhibiting a low fill rate 222.4 that is below a low fill rate threshold (filling very slowly). Similarly, when compared according to input/output operations per second (IOPS) 224, most of namespaces 212 may be in a medium range, but two namespaces 212.5 and 212.6 may be exhibiting significant variances from the medium range for IOPS. For example, namespace 224.5 may be exhibiting high IOPS 224.5 (e.g., 1.2 GB per second) that is above a high IOPS threshold and namespace 212.6 may be exhibiting low IOPS 224.6 (e.g., 150 megabytes (MB) per second) that is below a low IOPS threshold. When compared according to whether read operations or write operations are dominant (R/W 226), most namespaces 212 may be in a range with relatively balanced read and write operations, but two namespaces 212.7 and 212.8 may be exhibiting significant variances from the medium range for read/write operation balance. For example, namespace 212.6 may be exhibiting read intensive operations 226.7 that are above a read operation threshold and namespace 212.8 may be exhibiting write intensive operations 226.8 that are above a write operation threshold. Similar normal ranges, variances, and thresholds may be defined for other operating parameters of the namespaces, such as sequential versus random writes/reads, write amplification/endurance metrics, time-dependent storage operation patterns, etc. Any or all of these operating metrics may contribute to operating types for managing allocation of capacity to and from a floating namespace pool.

To improve utilization of namespaces, each namespace may be identified as to whether they are able to contribute unutilized capacity to a floating capacity pool to reduce capacity starvation of namespaces with higher utilization. For example, a system administrator may set one or more flags when each namespace is created to determine whether it will participate in dynamic capacity allocation and, if so, how. Floating capacity for namespaces may consist of unused space from read-intensive namespaces and/or slow filling namespaces, along with unallocated memory locations from NVM sets and/or NVM endurance groups supported by the storage protocol. The floating capacity may not be exposed to or attached to any host, but maintained as a free pool stack of unused space, referred to as a floating namespace pool, from which the capacity can ben dynamically allocated to expand any starving namespace.

In the example shown in FIG. 2B, each namespace 212 has been configured with an initial allocated capacity of ten capacity units 230. For example, if each namespace is allocated 1 TB of memory locations, each capacity unit would be 100 GB of memory locations. Namespaces 212, other than namespace 212.1, have been configured to support a floating namespace pool (comprised of the white capacity unit blocks). Each namespace includes a guaranteed capacity 232 and most of the namespaces include flexible capacity 236. In some configurations, guaranteed capacity 232 may include a buffer capacity 234 above a current or expected capacity usage. For example, capacity units 230 with diagonal lines may represent utilized or expected capacity, capacity units 230 with dots may represent buffer capacity, and capacity units 230 with no pattern may be available in the floating namespace pool. Guaranteed capacity 232 may be the sum of utilized or expected capacity and the buffer capacity. The floating namespace pool may be comprised of the flexible capacity units from all of the namespaces and provide an aggregate pool capacity that is the sum of those capacity units. For example, the floating namespace pool may include two capacity units from namespaces 212.2 and 212.5, five capacity units from namespaces 212.3 and 212.6, and one capacity unit from namespaces 212.4, 212,7 and 212.8, for an aggregate pool capacity of 17 capacity units. The allocations may change over time as capacity blocks from the floating namespace pool are used to expand the guaranteed capacity of namespaces that need it. For example, as fast filling namespace 212.3 receives more host data, capacity units may be allocated from the floating namespace pool to the guaranteed capacity needed for the host storage operations. The capacity may initially be claimed from the floating capacity blocks normally allocated to namespace 212.3, but may ultimately require capacity blocks from other namespaces, resulting in a guaranteed capacity larger than the initial 10 capacity units.

As described below, initial values for guaranteed storage and contributions to flexible capacity may be determined when each namespace is created. Some namespaces, such as namespace 212.1, may not participate in the floating namespace pool at all and may be configured entirely with guaranteed capacity, similar to prior namespace configurations. This may allow some namespaces to opt out of the dynamic allocation and provide guaranteed capacity for critical applications and host data. Some namespaces may use a system default for guaranteed and flexible capacity values. For example, the system may be configured to allocate a default portion of the allocated capacity to guaranteed capacity and a remaining portion to flexible capacity. In one configuration, the default guaranteed capacity may be 50% and the default flexible capacity may be 50%. So, for namespaces with the default configuration, such as namespaces 212.3 and 212.6, the initial guaranteed capacity value may be 5 capacity units and the flexible capacity value may be 5 capacity units. Some namespaces may use custom allocations of guaranteed and flexible capacity. For example, during namespace creation, the new namespace command may include custom capacity attributes to allow custom guaranteed capacity values and corresponding custom flexible capacity values. In the example shown, the remaining namespaces may have been configured with custom capacity attributes resulting in, for example, namespaces 212.2 and 212.5 having guaranteed capacity values of 8 capacity units and flexible capacity values of 2 capacity units. Additionally (as further described below), the guaranteed capacity values may change from the initial values over time as additional guaranteed capacity is allocated to namespaces that need it.

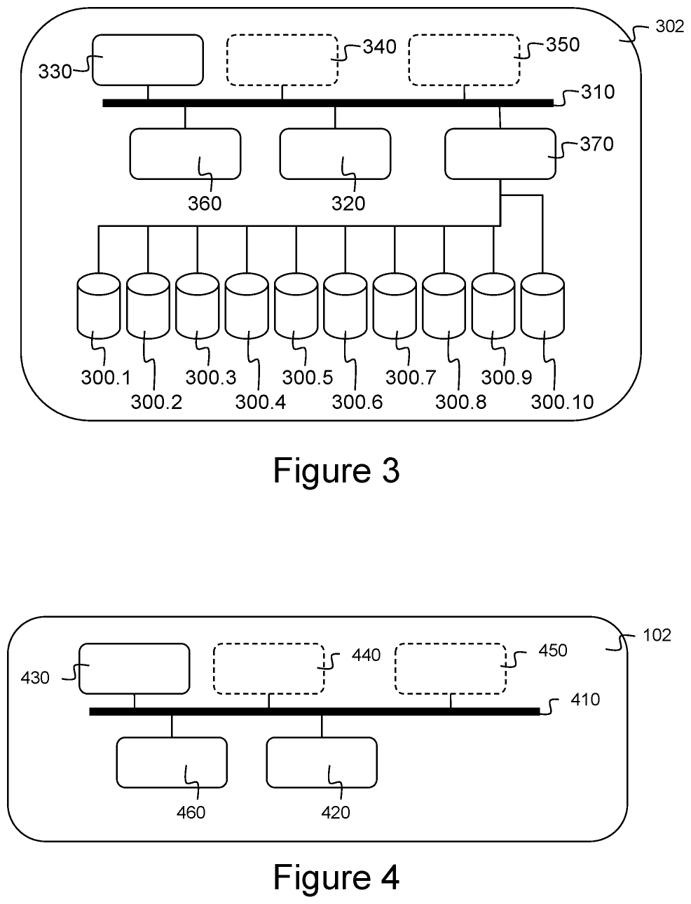

FIG. 3 shows a schematic representation of a storage node 302. For example, storage controller 102 may be configured as a storage node 302 for accessing storage devices 120 as storage elements 300. Storage node 302 may comprise a bus 310, a storage node processor 320, a storage node memory 330, one or more optional input units 340, one or more optional output units 350, a communication interface 360, a storage element interface 370 and a plurality of storage elements 300.1-300.10. In some embodiments, at least portions of bus 310, processor 320, local memory 330, communication interface 360, storage element interface 370 may comprise a storage controller, backplane management controller, network interface controller, or host bus interface controller, such as storage controller 102. Bus 310 may include one or more conductors that permit communication among the components of storage node 302. Processor 320 may include any type of conventional processor or microprocessor that interprets and executes instructions. Local memory 330 may include a random-access memory (RAM) or another type of dynamic storage device that stores information and instructions for execution by processor 320 and/or a read only memory (ROM) or another type of static storage device that stores static information and instructions for use by processor 320. Input unit 340 may include one or more conventional mechanisms that permit an operator to input information to said storage node 302, such as a keyboard, a mouse, a pen, voice recognition and/or biometric mechanisms, etc. Output unit 350 may include one or more conventional mechanisms that output information to the operator, such as a display, a printer, a speaker, etc. Communication interface 360 may include any transceiver-like mechanism that enables storage node 302 to communicate with other devices and/or systems, for example mechanisms for communicating with other storage nodes 302 or host systems 112. Storage element interface 370 may comprise a storage interface, such as a Serial Advanced Technology Attachment (SATA) interface, a Small Computer System Interface (SCSI), PCIe, etc., for connecting bus 310 to one or more storage elements 300, such as one or more storage devices 120, for example, 2 terabyte SATA-II disk drives or 2 TB NVMe solid state drives (SSDs), and control the reading and writing of data to/from these storage elements 300. As shown in FIG. 3, such a storage node 302 could comprise ten 2 TB NVMe SSDs as storage elements 300.1-300.10 and in this way storage node 302 would provide a storage capacity of 20 TB to the storage system 100.

Storage elements 300 may be configured as redundant or operate independently of one another. In some configurations, if one particular storage element 300 fails its function can easily be taken on by another storage element 300 in the storage system. Furthermore, the independent operation of the storage elements 300 allows to use any suitable mix of types storage elements 300 to be used in a particular storage system 100. It is possible to use for example storage elements with differing storage capacity, storage elements of differing manufacturers, using different hardware technology such as for example conventional hard disks and solid-state storage elements, using different storage interfaces, and so on. All this results in specific advantages for scalability and flexibility of storage system 100 as it allows to add or remove storage elements 300 without imposing specific requirements to their design in correlation to other storage elements 300 already in use in that storage system 100.

FIG. 4 shows a schematic representation of an example host system 112. Host system 112 may comprise a bus 410, a processor 420, a local memory 430, one or more optional input units 440, one or more optional output units 450, and a communication interface 460. Bus 410 may include one or more conductors that permit communication among the components of host 112. Processor 420 may include any type of conventional processor or microprocessor that interprets and executes instructions. Local memory 430 may include a random access memory (RAM) or another type of dynamic storage device that stores information and instructions for execution by processor 420 and/or a read only memory (ROM) or another type of static storage device that stores static information and instructions for use by processor 420 and/or any suitable storage element such as a hard disc or a solid state storage element. An optional input unit 440 may include one or more conventional mechanisms that permit an operator to input information to host 112 such as a keyboard, a mouse, a pen, voice recognition and/or biometric mechanisms, etc. Optional output unit 450 may include one or more conventional mechanisms that output information to the operator, such as a display, a printer, a speaker, etc. Communication interface 460 may include any transceiver-like mechanism that enables host 112 to communicate with other devices and/or systems.

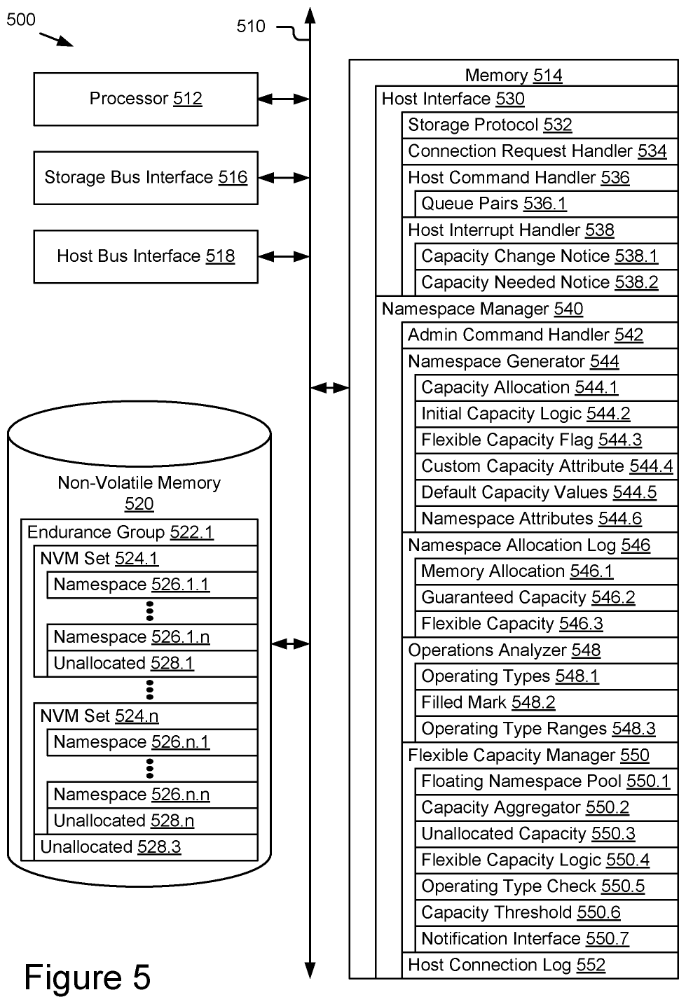

FIG. 5 schematically shows selected modules of a storage node 500 configured for dynamic allocation of namespace capacity using a floating namespace pool. Storage node 500 may incorporate elements and configurations similar to those shown in FIGS. 1-3. For example, storage node 500 may be configured as storage controller 102 and a plurality of storage devices 120 supporting host connection requests and storage operations from host systems 112 over fabric network 114. In some embodiments, the functions of host interface 530, namespace manager 540, and non-volatile memory 520 may all be instantiated in a single data storage device, such as one of data storage devices 120.

Storage node 500 may include a bus 510 interconnecting at least one processor 512, at least one memory 514, and at least one interface, such as storage bus interface 516 and host bus interface 518. Bus 510 may include one or more conductors that permit communication among the components of storage node 500. Processor 512 may include any type of processor or microprocessor that interprets and executes instructions or operations. Memory 514 may include a random access memory (RAM) or another type of dynamic storage device that stores information and instructions for execution by processor 512 and/or a read only memory (ROM) or another type of static storage device that stores static information and instructions for use by processor 512 and/or any suitable storage element such as a hard disk or a solid state storage element.

Storage bus interface 516 may include a physical interface for connecting to one or more data storage devices using an interface protocol that supports storage device access. For example, storage bus interface 516 may include a PCIe or similar storage interface connector supporting NVMe access to solid state media comprising non-volatile memory devices 520. Host bus interface 518 may include a physical interface for connecting to a one or more host nodes, generally via a network interface. For example. host bus interface 518 may include an ethernet connection to a host bus adapter, network interface, or similar network interface connector supporting NVMe host connection protocols, such as RDMA and transmission control protocol/internet protocol (TCP/IP) connections. In some embodiments, host bus interface 518 may support NVMeoF or similar storage interface protocols.

Storage node 500 may include one or more non-volatile memory devices 520 or similar storage elements configured to store host data. For example, non-volatile memory devices 520 may include at least one SSD and/or a plurality of SSDs or flash memory packages organized as an addressable memory array. In some embodiments, non-volatile memory devices 520 may include NAND or NOR flash memory devices comprised of single level cells (SLC), multiple level cell (MLC), triple-level cells, quad-level cells, etc. Host data in non-volatile memory devices 520 may be organized according to a direct memory access storage protocol, such as NVMe, to support host systems storing and accessing data through logical host connections. Non-volatile memory devices 520, such as the non-volatile memory devices of an SSD, may be allocated to a plurality of namespaces 526 that may then be attached to one or more host systems for host data storage and access. Namespaces 526 may be created with allocated capacities based on the number of namespaces and host connections supported by the storage device. In some configurations, namespaces may be grouped in non-volatile memory sets 524 and/or endurance groups 522. These groupings may be configured for the storage device based on the physical configuration of non-volatile memory devices 520 to support efficient allocation and use of memory locations. These groupings may also be hierarchically organized as show, with endurance groups 522 including NVM sets 524 that include namespaces 526. In some configurations, endurance groups 522 and/or NVM sets 524 may be defined to include unallocated capacity 528, such as memory locations in the endurance group or NVM set memory devices that are not yet allocated to namespaces to receive host data. For example, endurance group 522 may include NVM sets 524.1-524.n and may also include unallocated capacity 528.3. NVM sets 524.1-524.n may include namespaces 526.1.1-526.1.n to 526.n.1-526.n.n and unallocated capacity 528.1 and 528.n.

Storage node 500 may include a plurality of modules or subsystems that are stored and/or instantiated in memory 514 for execution by processor 512 as instructions or operations. For example, memory 514 may include a host interface 530 configured to receive, process, and respond to host connection and data requests from client or host systems. Memory 514 may include a namespace manager 540 configured to manage the creation and capacity of namespaces using a floating namespace pool.

Host interface 530 may include an interface protocol and/or set of functions and parameters for receiving, parsing, responding to, and otherwise managing requests from host nodes or systems. For example, host interface 530 may include functions for receiving and processing host requests for establishing host connections with one or more namespaces stored in non-volatile memory 520 for reading, writing, modifying, or otherwise manipulating data blocks and their respective client or host data and/or metadata in accordance with host communication and storage protocols. In some embodiments, host interface 530 may enable direct memory access and/or access over NVMeoF protocols, such as RDMA and TCP/IP access, through host bus interface 518 and storage bus interface 516 to host data units stored in non-volatile memory devices 520. For example, host interface 530 may include host communication protocols compatible with ethernet and/or another host interface that supports use of NVMe and/or RDMA protocols for data access to host data 520.1. Host interface 530 may be configured for interaction with a storage driver of the host systems and enable non-volatile memory devices 520 to be directly accessed as if they were local storage within the host systems. For example, connected namespaces in non-volatile memory devices 520 may appear as storage capacity within the host file system and defined volumes and data units managed by the host file system.

In some embodiments, host interface 530 may include a plurality of hardware and/or software modules configured to use processor 512 and memory 514 to handle or manage defined operations of host interface 530. For example, host interface 530 may include a storage protocol 532 configured to comply with the physical, transport, and storage application protocols supported by the host for communication over host bus interface 518 and/or storage bus interface 516. For example, host interface 530 may include a connection request handler 534 configured to receive and respond to host connection requests. For example, host interface 530 may include a host command handler 536 configured to receive host storage commands to a particular host connection. For example, host interface 530 may include a host interrupt handler configured to provide interrupt commands to the host systems. In some embodiments, host interface 530 may include additional modules (not shown) for command handling, buffer management, storage device management and reporting, and other host-side functions.

In some embodiments, storage protocol 532 may include both PCIe and NVMe compliant communication, command, and syntax functions, procedures, and data structures. In some embodiments, storage protocol 532 may include an NVMeoF or similar protocol supporting RDMA, TCP/IP, and/or other connections for communication between host nodes and target host data in non-volatile memory 520, such as namespaces attached to the particular host by at least one host connection. Storage protocol 532 may include interface definitions for receiving host connection requests and storage commands from the fabric network, as well as for providing responses to those requests and commands. In some embodiments, storage protocol 532 may assure that host interface 530 is compliant with host request, command, and response syntax while the backend of host interface 530 may be configured to interface with connection namespace manager 540 to provide dynamic allocation of capacity among namespaces.

Connection request handler 534 may include interfaces, functions, parameters, and/or data structures for receiving host connection requests in accordance with storage interface protocol 532, determining an available processing queue, such as a queue-pair, allocating the host connection (and corresponding host connection identifier) to a storage device processing queue, and providing a response to the host, such as confirmation of the host storage connection or an error reporting that no processing queues are available. For example, connection request handler 534 may receive a storage connection request for a target namespace in a NVMe-oF storage array and provide an appropriate namespace storage connection and host response. In some embodiments, connection request handler 534 may interface with namespace manager 540 to update host connection log 552 for new host connections. For example, connection request handler 534 may generate entries in a connection log table or similar data structure indexed by host connection identifiers and including corresponding namespace and other information.

In some embodiments, host command handler 536 may include interfaces, functions, parameters, and/or data structures to provide a function similar to connection request handler 534 for storage requests directed to the host storage connections allocated through connection request handler 534. For example, once a host storage connection for a given namespace and host connection identifier is allocated to a storage device queue-pair, the host may send any number of storage commands targeting data stored in that namespace. Host command handler 536 may maintain queue pairs 336.1 that include a command queue for storage commands going to non-volatile memory devices 520 and a response or completion queue for responses indicating command state and/or returned host data locations, such as read data written to the corresponding host memory buffer for access by the host systems. In some configurations, host command handler 536 passes host storage commands to the storage device command queues and corresponding NVM device manager (not shown) for executing host data operations related to host storage commands received through host interface 530 once a host connection is established. For example, PUT or Write commands may be configured to write host data units to non-volatile memory devices 520. GET or Read commands may be configured to read data from non-volatile memory devices 520. DELETE or Flush commands may be configured to delete data from non-volatile memory devices 520, or at least mark a data location for deletion until a future garbage collection or similar operation actually deletes the data or reallocates the physical storage location to another purpose.

In some embodiments, host interrupt handler 538 may include interfaces, functions, parameters, and/or data structures to enable storage node 500 to communicate with the host systems outside of the storage commands and responses supported by host command handler 536. For example, host interrupt handler 538 may respond to storage device states and events to provide interrupt commands to the host systems through storage protocol 532 and a storage driver of the host systems. In some embodiments, namespace manager 540 may generate one or more notification events and pass handling of those notification events to host interrupt handler 538. For example, when the guaranteed capacity of a namespace changes, a capacity change notification 538.1 may be sent to the connected host system for that namespace as an interrupt command. As another example, when a floating namespace capacity threshold is reached and indicates that the storage device is low on floating namespace capacity, a capacity needed notification 538.2 may be sent to the host systems and/or a storage system administrator to indicate that a new storage device should be added (or other system level configuration changes should be made) to assure continued available capacity for the host applications.

Namespace manager 540 may include an interface protocol and/or set of functions, parameters, and data structures for defining new namespaces in non-volatile memory devices 520 and managing changes in capacity using a floating namespace pool. For example, namespace manager 540 may receive new namespace requests for a data storage device to allocate the capacity of that storage device among a set of namespaces with allocated capacities of a defined capacity value, such as dividing the 8 TB capacity of a storage device among eight different namespaces. Namespace manager 540 may process command parameters and/or configuration settings for the new namespaces to determine whether and how each namespace supports the floating namespace pool for flexible capacity. For example, each namespace request may include one or more request parameters corresponding to enabling flexible capacity and defining the guaranteed and flexible capacity allocations for that namespace. Once the namespace capacity allocations are defined, namespace manager 540 may monitor and algorithmically and automatically adjust capacity allocations of the set of namespaces by reallocating capacity units from the floating namespace pool to namespaces that need additional capacity. Namespace manager 540 may also send, in cooperation with host interface 530, notifications to host and/or administrative systems as namespace capacities change and/or more capacity is needed.

In some embodiments, namespace manager 540 may include a plurality of hardware and/or software modules configured to use processor 512 and memory 514 to handle or manage defined operations of namespace manager 540. For example, namespace manager 540 may include and/or access an administrative command handler 542 configured to communicate with an administrator system for namespace requests, configuration, and administrative notifications. For example, namespace manager 540 may include and/or access a namespace generator 544 configured to allocate namespaces on non-volatile memory devices 520 in response to namespace requests received through host interface 530 and/or administrative command handler 542. For example, namespace manager 540 may include and/or access a namespace allocation log 546 configured to record and maintain capacity allocations for the namespaces and floating namespace pool. For example, namespace manager 540 may include and/or access an operations analyzer configured to determine operating characteristics of the namespaces. For example, namespace manager 540 may include and/or access a flexible capacity manager 550 configured to manage the floating namespace pool and capacity changes for the namespaces. For example, namespace manager 540 may include and/or access a host connection log 552 configured to record and maintain a log of the active host connections for the namespaces.

Administrative command handler 542 may include interfaces, functions, parameters, and/or data structures to interact with an administrative system used to provision and configure namespaces for use by the host systems. For example, one or more host systems and/or a dedicated administrative system may include an administrative user interface for configuring and monitoring the storage system including storage node 500. Administrative command handler 542 may provide an interface for receiving administrative commands, such as new namespace, NVM set, and/or endurance group requests, for namespace manager 540. In some embodiments, administrative command handler 542 may receive namespace requests and parse a set of namespace parameters related to the request for use by namespace generator 544. For example, administrative command handler may determine the request type and parse request parameters corresponding to namespace capacity allocation, enabling flexible capacity, and/or guaranteed capacity allocation. In some embodiments, storage protocol 532 may define the administrative commands and predetermined locations within those commands for the request parameters used by namespace generator 544.

Namespace generator 544 may include interfaces, functions, parameters, and/or data structures to allocate and configure new namespaces for non-volatile memory devices 520. For example, when a new storage device is added to storage node 500, the storage device may have a storage device configuration that determines a total available capacity and a number of namespaces that can be supported by the device. Namespace generator 544 may receive new namespace request parameters from administrative command handler 542 and use them to configure each new namespace in the new storage device. In some embodiments, namespace generator 544 may determine a capacity allocation 544.1 for the namespace. For example, the namespace request may include a capacity allocation value for the new namespace based on how the system administrator intends to allocate the memory space in the storage device's non-volatile memory devices, such as dividing the memory locations equally among a number of namespaces or individually allocating different allocated capacities to each namespace. Once capacity allocation 546.1 is determined, a set of memory locations in non-volatile memory devices 520 meeting capacity allocation 546.1 may be associated with the namespace. In some configurations, the namespace may be associated with an NVM set and/or endurance group and the memory locations may be selected from the set of memory locations previously assigned to the corresponding NVM set and/or endurance group.

Namespace generator 544 may include initial capacity logic 544.2 for determining whether a new namespace is participating in the flexible capacity feature of the storage device and make the initial allocations of guaranteed capacity and flexible capacity. Initial capacity logic 544.2 may use request parameter values related to the namespace creation request to determine the initial capacities and how they are allocated between guaranteed and flexible capacity. One or more flexible capacity flags 544.3 may determine whether or not the namespace will participate in the floating namespace pool and dynamic capacity allocation. For example, the namespace request may include flexible capacity flag 544.3 in a predetermined location in the request message and the value of the flag may be parsed by admin command handler 542 and passed to namespace generator 544. Where the namespace is part of an NVM set and/or endurance group, initial capacity logic 544.2 may check flag values related to the NVM set and/or endurance group to see whether flexible capacity is enabled. In some configurations, these parameters may also determine whether unallocated capacity from the NVM set and/or endurance group may be used to support the floating capacity pool (in addition to the flexible capacity from each participating namespace). For example, namespace generator 544 may check whether the namespace is part of an NVM set or endurance group and check the NVM set or endurance group for the flag, such as the 127^{th} bit of the NVM set list or an NVM set attribute entry for the endurance group. In some embodiments, flexible capacity flag 544.3 may be set for the namespace based on a vendor specific field in the namespace create data structure or reserved field of the command Dword. For example, within a vendor specific field defined by the storage protocol specification, such as command Dword 11 of the create namespace data structure, one or more bits may be defined as flexible capacity flag 544.3, with a 1 value indicating that flexible capacity should be enabled for the namespace and a 0 value indicating that flexible capacity should not be enabled for the namespace. Similarly, a reserved field, such as command Dword 11, may include bits reserved for namespace management parameters related to selecting namespace management operations and one of these bits may be used to define a namespace creation operation that enables flexible namespace.

Once a namespace is determined to participate in the flexible capacity and floating namespace pool, initial capacity logic 544.2 may determine initial values for the guaranteed capacity and the flexible capacity of the namespace. For example, allocated capacity 544.1 may be divided between a guaranteed capacity value and a flexible capacity value, where the sum of those values equals the allocated capacity value for the namespace. In some embodiments, each namespace that is not being enabled for flexible capacity may treat its entire capacity allocation 544.1 as guaranteed capacity. For example, 1 TB namespace would have a guaranteed capacity of 1 TB (all capacity units in the namespace) and a flexible capacity of zero. In some embodiments, initial capacity logic 544.2 may use custom capacity attribute 544.4 and/or default capacity values 544.5 to determine the initial capacity values. For example, the namespace request may include a field for custom capacity attribute 544.4 containing one or more custom capacity parameter values for setting the guaranteed capacity and/or flexible capacity values. If the custom capacity attribute 544.4 is not set, then initial capacity logic 544.2 may use default capacity values 544.5. In some embodiments, the storage system may include configuration settings for default capacity values 544.5, such as a default guaranteed capacity value and a default flexible capacity value, such as 50% guaranteed capacity and 50% flexible capacity. In some embodiments, the default capacity values may include a plurality of guaranteed/flexible capacity values that are mapped to different operating types, as described below for operations analyzer 548, and may receive an operating type used as a key for indexing the default values, such as from operations analyzer 548 or from an operating type parameter configured in the namespace request. Namespace generator 544 may determine a set of namespace attributes 544.6 for the new namespace, including the initial guaranteed and flexible capacity values, and provide those namespace attributes to other components, such as a namespace directory used by host systems to connect to the new namespace and/or namespace allocation log 546.

Namespace allocation log 546 may include interfaces, functions, parameters, and/or data structures to store the initial capacity allocation values for new namespaces and manage changes to those values during flexible capacity operations. For example, namespace allocation log 546 may include a data structure or algorithm for indicating the memory locations corresponding to capacity allocation 544.1. Memory allocation 546.1 may indicate the specific sets of memory locations in non-volatile memory 520 and whether they are guaranteed capacity 546.2 or flexible capacity 546.3 for that namespace. As further described below, the memory locations may be reallocated in capacity units over time as the floating namespace pool is used to support expansion of the guaranteed capacity of the namespaces that need it. For example, namespace allocation log 546 may include a map or similar lookup table or function for each namespace's memory allocation 546.1 and which memory locations or capacity units are currently allocated as guaranteed capacity 546.2 or flexible capacity 546.3.

Operations analyzer 548 may include interfaces, functions, parameters, and/or data structures to analyze the data storage operations, including host data and command types and patterns, for determining how a namespace is being used. For example, operations analyzer 548 may analyze a set of host operations to the namespace to determine whether the namespace is slow filling, fast filling, or within a normal or medium fill range. Operating types 548.1 for the namespaces may be used by flexible capacity manager 550 to determine when and whether namespaces should be allocated additional guaranteed capacity from the floating namespace pool and which namespaces should provide the additional capacity from their flexible capacity. In some embodiments, operations analyzer 548 may include or access a dataset management function or service of storage node 500 and/or the specific storage device for determining one or more operating parameters of the namespace. For example, the dataset management function may be configured to process transaction logs to monitor operating parameters, such as read operations, write operations, operations per unit time, memory/capacity usage, endurance metrics, etc. In some embodiments, operations analyzer 548 may determine operating parameters for fill rate, read versus write (e.g., percentage of read commands versus write commands), IOPS, and the current used capacity of the namespace (e.g., filled mark 548.2 corresponding to the memory locations and/or capacity units in the namespace currently storing host data). In some embodiments, operations analyzer 548 may use the operating parameters to classify each namespace into one or more operating types, such as a fast filling type or a slow filling type, a high read type or a high write type, or a high performance type or a low performance type. For example, operations analyzer 548 may include operating type ranges 548.3 that map operating parameter values to the operating types. In some embodiments, operating type ranges 548.3 may define at least one operating parameter threshold value that, if met, defines the namespace as one type or another. For example, a fill rate threshold may define whether a fill rate value for the namespace is classified as a fast filling namespace or a slow filling namespace. In some embodiments, operating type ranges 548.3 may define more than two types using multiple ranges and thresholds, such high, medium/normal, and low types. In some embodiments, operating type ranges 548.3 may include mapping multiple operating parameters to one or more operating types. For example, whether a namespace is classified as fast filling or slow filling may be based on mapping read versus write, IOPS, and change rates for filled mark 546.3 using weighted factors for each operating parameter to determine a composite fill rate value and corresponding fill rate type.

Flexible capacity manager 550 may include interfaces, functions, parameters, and/or data structures to determine floating namespace pool 550.1 and allocate flexible capacity from the pool to namespaces that need it. For example, once the initial capacity values are determined for the set of namespaces in a storage device, flexible capacity manager 550 may monitor storage operations and/or operating parameters from operations analyzer 548 to determine when a namespace has exceeded or is approaching its guaranteed capacity and allocate additional capacity units to that namespace. Floating namespace pool 550.1 may include the plurality of capacity units allocated to flexible capacity for the set of namespaces. For example, flexible capacity manager 550 may include a capacity aggregator 550.2 that sums the capacity units in the flexible capacity portion of each namespace in the set of namespaces to determine the aggregate capacity of floating namespace pool 550.1. In some embodiments, flexible capacity manager 550 may also have access to unallocated capacity 550.3 from other regions of non-volatile memory devices 520. For example, unallocated capacity 550.3 may include some or all of unallocated memory locations in one or more NVM sets and/or endurance groups. In this context, unallocated memory locations may be those memory locations that are associated with an NVM set and/or endurance group but are not allocated to a namespace within that NVM set and/or endurance group, such as unallocated memory 528.

Flexible capacity manager 550 may include flexible capacity logic 550.4 that monitors and responds to changes in the capacity used for host data in each namespace. For example, each time a storage operation is processed or on some other time interval or event basis, flexible capacity logic 550.4 may determine the filled mark for the target namespace for the storage operation and/or each namespace and evaluate the filled mark relative to the guaranteed capacity to determine whether additional capacity is needed by that namespace. In some embodiments, flexible capacity logic 550.4 may also include an operating type check to determine one or more operating types for the namespace, such as operating types 548.1 from operations analyzer 548, as a factor in determining whether additional capacity is need by that namespace and/or from which other namespace's flexible capacity the additional capacity should come from. For example, flexible capacity logic 550.4 may check whether the namespace is fast filling or slow filling for the purposes of determining when and whether to add guaranteed capacity and/or decrease flexible capacity for a namespace.

Flexible capacity manager 550 may use one or more capacity thresholds 550.6 for determining whether and when capacity should be added to a namespace. For example, flexible capacity manager 550 may use a flexible capacity threshold to evaluate the filled mark for the namespace to trigger the addition of capacity. In some embodiments, the flexible capacity threshold may be set at a portion of the guaranteed capacity, such 50%, 80%, or 90%, with the complementary portion corresponding to a buffer capacity in the guaranteed capacity. So, when the filled mark meets the flexible capacity threshold, such as X % of the guaranteed capacity (or guaranteed capacity—X, if X is a fixed buffer capacity), flexible capacity logic 550.4 selects at least one capacity unit from floating namespace pool 550.1 to expand the guaranteed capacity of that namespace. For example, a number of capacity units at least meeting a difference between the filled mark and capacity threshold 550.6 (the amount the filled mark is over the capacity threshold). In some embodiments, the flexible capacity thresholds may be based on amount of flexible capacity being used (i.e., the filled mark is allowed to exceed the guaranteed capacity until a threshold amount of flexible capacity it used). For example, the flexible capacity threshold may be set at 50% of the flexible capacity, so when the filled mark meets or exceeds guaranteed capacity +50% of flexible capacity, the addition of capacity may be triggered. Note that adding capacity units to the namespace increases the total capacity allocation for that namespace, adding new memory locations to memory allocation 546.1. As a result, guaranteed capacity 546.2 and flexible capacity 546.3 may also be recalculated by flexible capacity logic 550.4. For example, the number of added capacity units may be added to the guaranteed capacity (and the flexible capacity may remain unchanged). In some embodiments, guaranteed capacity 546.2 may at least be increased to the current filled mark and/or filled mark plus buffer capacity.

In some embodiments, flexible capacity logic 550.4 may also determine which other namespace the capacity units from floating namespace pool 550.1 are moved from. For example, flexible capacity logic 550.4 may include a guaranteed capacity threshold compared to the filled mark of the source namespace and an operating type of the source namespace to determine whether the capacity units can be spared. In some configurations, flexible capacity logic 550.4 may organize floating namespace pool 550.1 into a prioritized stack of capacity units from the different namespaces and, in some cases, may include unallocated capacity 550.3. Flexible capacity logic 550.4 may select the next capacity unit from the stack to provide needed capacity to a target namespace. Additional aspects of flexible capacity logic 550.4 may be described with regard to the methods and examples below.

In some embodiments, flexible capacity logic 550.4 may include one or more thresholds or events that trigger notifications to other systems. For example, when a namespace (total) capacity allocation is changed because capacity units have been added or removed, a capacity change notification should be sent to connected host systems. As another example, an aggregate capacity threshold may be evaluated against the capacity units remaining in floating namespace pool 550.1 to determine when a host system and/or administrative system should be notified that more capacity is need for storage node 500 and additional storage units should be added. Flexible capacity manager 550 may include a notification interface 550.7 for passing notification requests to admin command handler 542 and/or host interrupt handler 538. For example, each time capacity units are moved from a source namespace to a target namespace, one or more capacity change notification may be generated to invoke command interrupts to the effected host systems.

Host connections log 552 may include interfaces, functions, parameters, and/or data structures to map the namespaces to one or more host connection. For example, after namespaces are created by namespace generator 544, they may be included in a discovery log for storage node 500 and/or the storage device allocated the namespace. Host systems may discover the namespaces in storage node 500 and/or the storage device and request host connections to those namespaces as needed by their applications and determined by storage protocol 532. In some embodiments, host interface 530 may use host connection log 552 to determine the host systems and interrupt command paths for host interrupt handler 538,

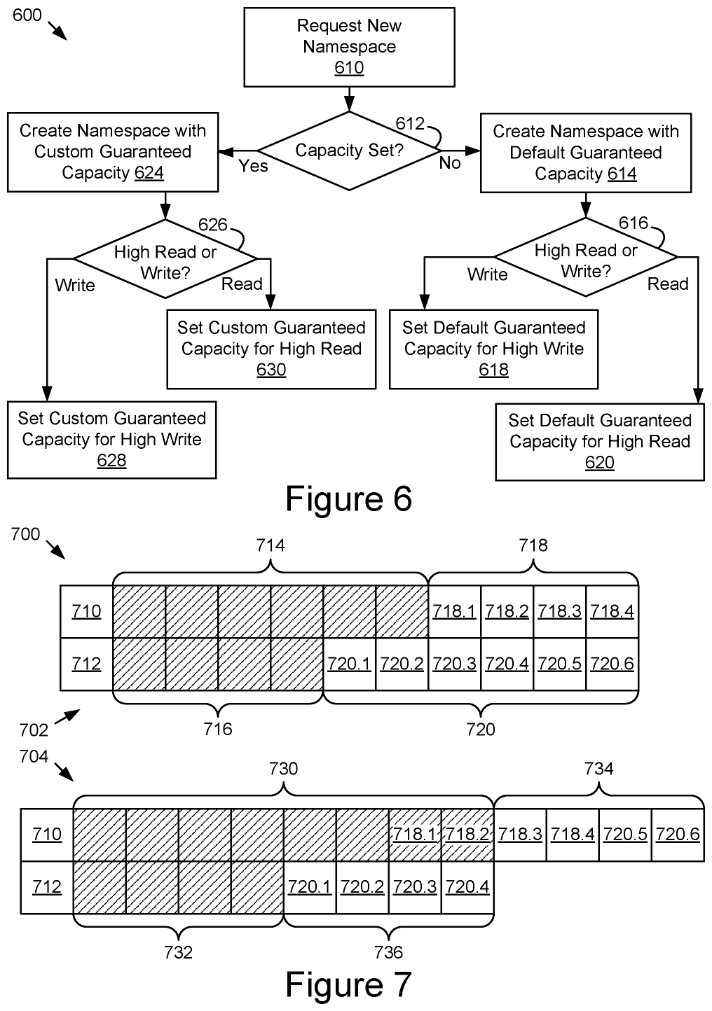

As shown in FIG. 6, storage node 500 may be operated according to an example method for setting guaranteed capacity for a new namespace, i.e., according to method 600 illustrated by blocks 610-628 in FIG. 6.

At block 610, a new namespace may be requested. For example, the storage node may receive a namespace request or create command from an administrative system for a new namespace to be created in the non-volatile memory devices of a storage device.

At block 612, whether a custom capacity attribute has been set with a value for determining guaranteed capacity may be evaluated. For example, the namespace request may include request parameters with a defined location or tag for a custom guaranteed capacity attribute value and that custom guaranteed capacity attribute may be evaluated to determine whether a custom value has been set by the user. If no, method 600 may proceed to block 614. If yes, method 600 may proceed to block 622.

At block 614, a namespace may be created with a default guaranteed capacity. For example, the namespace may have an allocated capacity corresponding to a number of capacity units and the storage system may be configured with one or more default values for determining what portion of the allocated capacity is guaranteed capacity and what portion is flexible capacity.

At block 616, whether the namespace is configured for high read operations or high write operations may be determined. For example, the namespace request may include request parameters for indicating read intensive operating type or write intensive operating type. In some embodiments, this evaluation may not be performed until a sample set of storage operations have been performed to the new namespace and can be evaluated for operating type. If the namespace is a high write or low read operating type, method 600 may proceed to block 618. If the namespace is a high read or low write operating type, method 600 may proceed to block 620.

At block 618, a default guaranteed capacity value may be set to a default guaranteed capacity value for high write operating types. For example, the default capacity values may be included in a configuration table that maps operating types to default guaranteed capacity and flexible capacity values or percentages and the value from the configuration table may be used by storage device firmware to set or determine the default guaranteed capacity value for the namespace, such as 60% guaranteed and 40% flexible.

At block 620, the default guaranteed capacity value may be set to a default guaranteed capacity value for high read operating types. For example, the value from the configuration table for high read operating types may be used by storage device firmware to set or determine the default guaranteed capacity allocation (and corresponding default flexible capacity allocation) for the namespace, such as 50% guaranteed and 50% flexible capacity allocation.

At block 624, a namespace may be created with a custom guaranteed capacity. For example, the namespace may have an allocated capacity corresponding to a number of capacity units and the storage system may use the custom capacity attribute for determining what portion of the allocated capacity is guaranteed capacity and what portion is flexible capacity.

At block 626, whether the namespace is configured for high read operations or high write operations may be determined. For example, the namespace request may include request parameters for indicating read intensive operating type or write intensive operating type. In some embodiments, this evaluation may not be performed until a sample set of storage operations have been performed to the new namespace and can be evaluated for operating type. If the namespace is a high write or low read operating type, method 600 may proceed to block 628. If the namespace is a high read or low write operating type, method 600 may proceed to block 630.

At block 628, a custom guaranteed capacity value may be set to a custom guaranteed capacity value for high write operating types. For example, the custom capacity attribute may include multiple values mapped to different operating types or may include a seed custom capacity attribute value that may be mapped algorithmically by different factors for different operating types. The value corresponding to high write operating types may be used to set or determine the custom guaranteed capacity value for the namespace, such as 80% guaranteed and 20% flexible.

At block 630, the custom guaranteed capacity value may be set to a custom guaranteed capacity value for high read operating types. For example, the value from the namespace request may be used to determine a value for high read operating types that is used to set or determine the custom guaranteed capacity value for the namespace, such as 60% guaranteed and 40% flexible.

In FIG. 7, flexible capacity logic, such as the described above for flexible capacity manager 550 in storage node 500, for non-volatile memory 700 may take initial allocations 702 of capacity units and move them between namespaces 710 and 712 as needed to updated allocations 704. For example, namespaces 710 and 712 may both include initial allocated capacities of ten capacity units, where each capacity unit is a set of memory locations, such as a number of pages in a non-volatile memory device. In the example shown, the namespaces may have different initial guaranteed and flexible capacities. Namespace 710 may be a fast filling operating type configured with guaranteed capacity 714 of six capacity units and flexible capacity 718 of four capacity units 718.1-718.4. Namespace 712 may be a slow filling operating type configured with guaranteed capacity 716 of four capacity units and flexible capacity 720 of six capacity units 720.1-720.6. In initial allocation 702, the four capacity units of flexible capacity 718 and the six capacity units of flexible capacity 720 may be contributed to a floating capacity pool that would now include at least 10 capacity units (capacity units 718.1-718.4 and 720.1-720.6).

During operation of the storage device including memory 700, an event may be triggered to allocate capacity from the floating namespace pool to namespace 710. For example, the filled mark of namespace 710 may reach guaranteed capacity 714 or a guaranteed capacity threshold based on guaranteed capacity 714 and/or flexible capacity 718, such as 80% of guaranteed capacity 714 or guaranteed capacity 714 +50% of flexible capacity 718. Responsive to the guaranteed capacity threshold being met, the flexible capacity logic may determine a number of capacity units to be reallocated from the floating namespace pool to namespace 710 as shown in updated allocations 704. The number of capacity units allocated may be based on an update value that determines the number of capacity units to be moved. For example, a system or user configurable update value may set a fixed number of capacity units or a percentage of flexible capacity 718 to add to namespace 710, such as 50% of flexible capacity 718, which equals two capacity units. In the example shown, two capacity units are added to increase updated guaranteed capacity 730 to eight capacity units. For example, the first two capacity units 718.1 and 718.2 from initial or previous flexible capacity 718 are reallocated to updated guaranteed capacity 730. The size of the flexible capacity for namespace 710 may not change because additional capacity units from the floating namespace pool are added to updated flexible namespace 734, increasing the total allocation of capacity units to namespace 710 to twelve capacity units. Twelve capacity units may be a resized or updated total capacity allocation of namespace 710 in the updated allocation 704.

In this limited example, the floating namespace pool may only have the ten capacity units shown in initial allocation 702. The capacity units allocated to namespace 710 in updated allocation 704 may come from the flexible capacity of namespace 712. For example, capacity blocks 720.5 and 720.6 from the initial or previous flexible capacity 720 of namespace 712 may be reallocated to namespace 710 and added to updated flexible capacity 734 to resize its total allocated capacity. Note that during normal operation, a larger floating capacity pool may be available, including unallocated capacity from other memory locations, and the flexible capacity logic may organize the floating namespace pool in a prioritized stack of capacity units for resizing namespaces as more capacity is needed. The resulting reductions of capacity of other namespaces may continue until a low capacity threshold for the floating namespace pool triggers a notification to the system administrator that additional storage devices should be added.

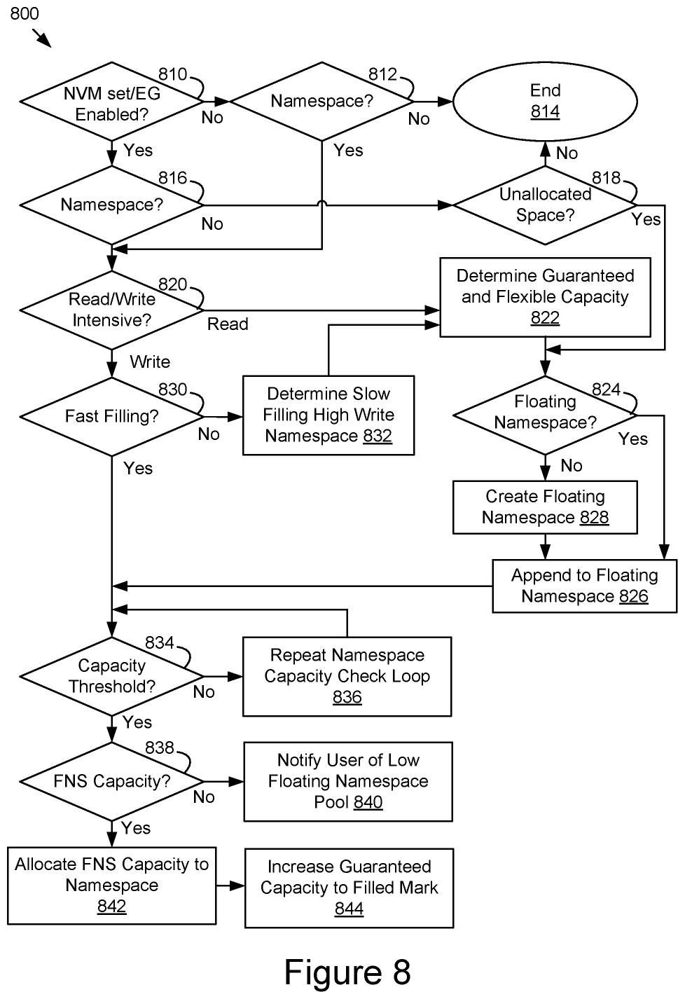

As shown in FIG. 8, storage node 500 may be operated according to an example method for dynamically adjusting namespace capacity using a floating namespace pool, i.e., according to method 800 illustrated by blocks 810-844 in FIG. 8.

At block 810, whether an NVM set and/or endurance group is configured to a storage device may be determined. For example, a namespace manager may check whether parameters for one or more NVM sets or endurance groups indicate that memory locations in the storage device are allocated to NVM sets or endurance groups. If no, method 800 may proceed to block 812. If yes, method 800 may proceed to block 816.

At block 812, whether a namespace is configured for the storage device may be determined. For example, the namespace manager may check whether one or more namespaces have been created for the storage device. If no, method 800 may proceed to block 814 and end. If yes, method 800 may proceed to block 820.

At block 816, whether a namespace is configured within the NVM set or endurance group may be determined. For example, the namespace manager may check whether one or more namespaces have been created in the NVM set or endurance group. If no, method 800 may proceed to block 818. If yes, method 800 may proceed to block 820.

At block 818, whether there is unallocated space in the NVM set and/or endurance group may be determined. For example, the namespace manager may check whether some or all memory locations in the NVM set and/or endurance group are not allocated to other uses and determine a corresponding unallocated capacity value. If no, method 800 may proceed to block 814 and end. If yes, method 800 may proceed to block 824 to append the unallocated memory locations from the NVM set and/or endurance group to the floating namespace pool.

At block 820, whether the namespace is used or configured for read intensive or write intensive storage operations may be determined. For example, the namespace may be configured or tagged with a operating type parameter that indicates read or write operating type and/or prior operations and host data stored to the namespace may be analyzed to determine operating type. If high read operating type, method 800 may proceed to block 822. If high write operating type, method 800 may proceed to block 830.

At block 822, guaranteed capacity and flexible capacity may be determined for the namespace. For example, the namespace manager may determine guaranteed capacity values and flexible capacity values for each namespace supporting flexible capacity and the floating namespace pool, such as described for method 600.

At block 824, whether a flexible namespace pool has been created for the storage device may be determined. For example, the namespace manager may determine whether a flexible namespace pool has already been configured. If yes, method 800 may proceed to block 826 to append the flexible capacity to the floating namespace pool. If no, method 800 may proceed to block 828 to create the floating namespace pool for the storage device.

At block 826, memory locations may be appended to the floating namespace pool. For example, the namespace manager may maintain a prioritized stack corresponding to blocks of memory locations (organized and measured as capacity units) that have been allocated to the floating namespace pool and add identified memory locations for flexible capacity and/or unallocated capacity to the stack.

At block 828, the floating namespace pool is created. For example, the namespace manager may generate logical to physical mapping for a pool of memory locations for the floating namespace pool, which is not exposed to the host systems as an addressable namespace.

At block 830, whether the namespace is fast filling may be determined. For example, the namespace may be configured or tagged with a operating type parameter that indicates fast filling or slow filling operating type and/or prior operations and host data stored to the namespace may be analyzed to determine operating type. If not fast filling operating type, method 800 may proceed to block 832. If fast filling operating type, method 800 may proceed to block 834.

At block 832, the namespace may be determined to be a slow filling and high write namespace. For example, the namespace manager may determine that even though the namespace is write intensive, it has a slow filling operating type (such as due to low overall IOPS or intermittent access) and may be used for flexible capacity.

At block 834, whether a capacity threshold is met may be evaluated for a namespace. For example, following each write operation or based on some other trigger event, the current filled mark of the namespace may be compared to a flexible capacity or guaranteed capacity threshold to determine whether capacity from the floating namespace pool should be allocated to the namespace. If the filled mark does not meet the capacity threshold, method 800 may proceed to block 836. If the filled mark does meet the capacity threshold, method 800 may proceed to block 838.

At block 836, the namespace capacity check loop may repeat at block 834. For example, the namespace manager may evaluate the capacity threshold for each namespace and each write operation until the capacity threshold is met.

At block 838, whether floating namespace capacity is available may be evaluated. For example, the namespace manager may monitor the remaining capacity of the floating namespace pool against a low capacity notification threshold to determine if capacity units from the floating namespace pool are still available for allocation. If no, method 800 may proceed to block 840. If yes, method 800 may proceed to block 842.

At block 840, a user may be notified of low capacity in the floating namespace pool. For example, the namespace manager may trigger a notification message to a system administrator indicating that the aggregate capacity of the floating namespace pool has fallen below the low capacity notification threshold and more storage space will be needed.

At block 842, floating namespace capacity may be allocated to the namespace. For example, the namespace manager may assign one or more capacity units from the floating namespace pool to the namespace that met the capacity threshold at block 834, as described above with regard to FIG. 7.

At block 844, the guaranteed capacity may be increased to the filled mark. For example, the namespace manager may increase the allocated capacity of the namespace based on the capacity units assigned at block 842, update the guaranteed capacity of the namespace to the filled mark (or the filled mark plus a buffer capacity), and update the flexible capacity value to reflect the remaining allocated capacity.

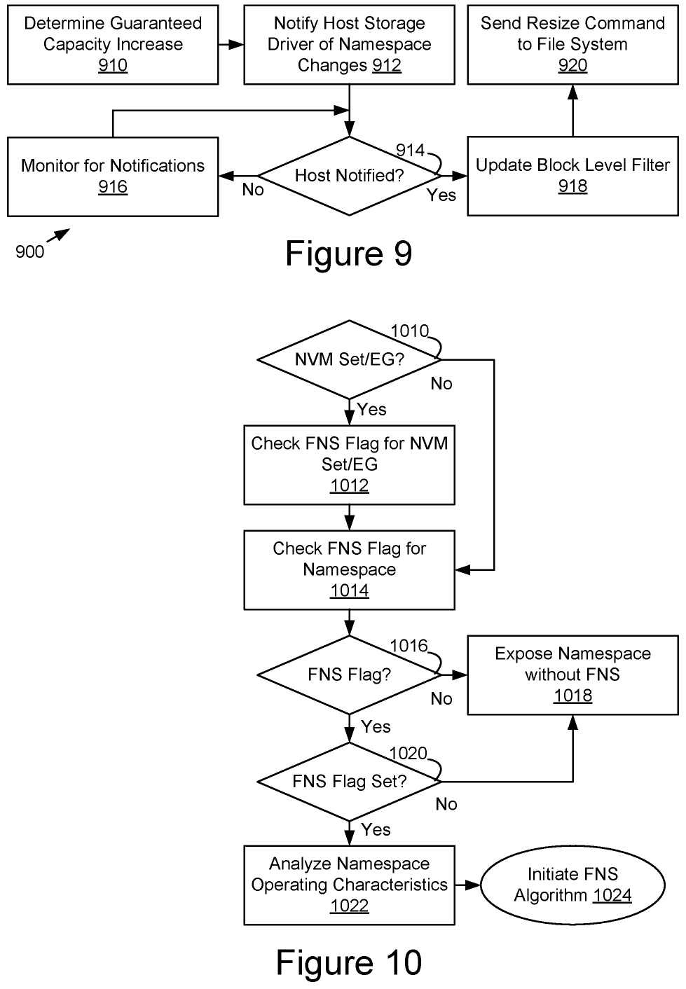

As shown in FIG. 9, storage node 500 may be operated according to an example method for notifying a host system to update its file system, i.e., according to method 900 illustrated by blocks 910-920 in FIG. 9.

At block 910, an increase in guaranteed capacity may be determined for a namespace. For example, a namespace manager may allocate additional capacity to a namespace from the floating namespace pool as described for FIGS. 7 and 8, increasing the guaranteed capacity and total capacity allocated to the namespace.

At block 912, a host storage driver may be notified of the namespace change. For example, the namespace manager may initiate a host interface to send an interrupt command with the updated capacity of the namespace to the connected host system.

At block 914, whether the host system has been notified may be evaluated. For example, the host storage driver may monitor for interrupt commands from the storage node or storage device and parse those interrupt commands to determine host notifications. If the host has not been notified, method 900 may proceed to block 916 to continue to monitor for host notifications. If the host has been notified, method 900 may proceed to block 918.

At block 918, a block level filter may be updated for the change in allocated capacity for the namespace. For example, the storage driver may include a block level filter that includes or accesses a logical mapping of the namespace to the volumes or other data units of the file system.

At block 920, a resize command is sent to the file system. For example, the block level filter may allow the storage driver to generate and send a resize command to the file system for the volume or other data units mapped to the namespace and the increased capacity may be included as a parameter of the resize command, enabling the host system to maintain accurate mapping of file system capacities to the namespace capacities of the storage node and/or storage device.

As shown in FIG. 10, storage node 500 may be operated according to an example method for determining floating namespace configuration for a namespace, i.e., according to method 1000 illustrated by blocks 1010-1024 in FIG. 10.

At block 1010, whether an NVM set and/or endurance group is configured for the storage device may be determined. For example, responsive to a namespace request, a namespace manager may check the state of NVM set and endurance group configuration settings for that namespace to see whether it is a part of an NVM set and/or endurance group. If yes, method 1000 may proceed to block 1012. If not, method 1000 may proceed to block 1014.

At block 1012, floating namespace flags may be checked for the identified NVM set and/or endurance group. For example, the namespace manager may check a specified field of the NVM set and/or endurance group configuration logs to determine whether they are enabled to support or allow floating namespaces and flexible capacity for the namespaces they contain.

At block 1014, a floating namespace flag may be checked for the namespace. For example, the namespace manager may check a flexible capacity flag in a specified location in the namespace request to determine whether the namespace is configured to support the floating namespace pool.

At block 1016, whether the floating namespace flag is defined for the namespace request may be determined. For example, not all systems and vendors may support flexible capacity supported by a floating namespace pool and the namespace manager may check whether or not the floating namespace flag is defined for the namespace. If the floating namespace flag is not present, method 1000 may proceed to block 1018. If the floating namespace flag is present, method 1000 may proceed to block 1020 to determine whether the floating namespace is set (indicating that the namespace will use flexible capacity). If the floating namespace flag is not set to use flexible capacity, method 1000 may proceed to block 1018. If the floating namespace flag is set to use flexible capacity, method 1000 may proceed to block 1022.

At block 1018, the namespace may be exposed without flexible capacity or contributing to the floating namespace pool. For example, the namespace manager may process the namespace request as normal without determining guaranteed and flexible capacity and contributing the flexible capacity to the floating namespace pool, resulting in the full allocated capacity of the namespace effectively being guaranteed capacity without any flexible capacity.

At block 1022, operating characteristics of the namespace may be analyzed. For example, the namespace manager may use an initial or prior set of storage operations to the namespace to determine one or more operating types, such as read/write and slow/fast filling operating types.

At block 1024, a flexible namespace algorithm may be initiated for the namespace. For example, the namespace manager may initiate a process for dynamically adjusting namespace capacity using a floating namespace pool, such as method 800, and/or a flexible capacity manager executing flexible capacity logic.

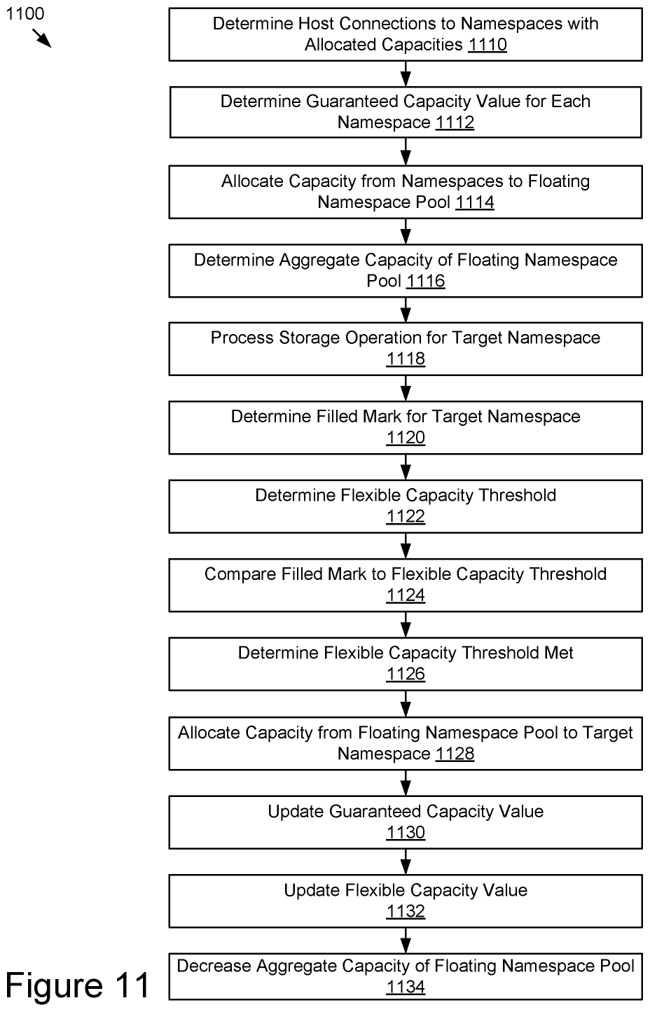

As shown in FIG. 11, storage node 500 may be operated according to an example method for using capacity from the floating namespace pool to allocate additional capacity to a namespace, i.e., according to method 1100 illustrated by blocks 1110-1134 in FIG. 11.

At block 1110, host connections may be determined to a set of namespaces with allocated capacities. For example, a namespace manager may be used to configure a set of namespaces that each have an allocated capacity corresponding to a defined set of memory locations in the storage device.

At block 1112, a guaranteed capacity may be determined for each namespace. For example, as each namespace was created, the namespace manager may have determined a guaranteed capacity value based on default or custom allocation of guaranteed and flexible capacity.

At block 1114, capacity from the namespaces may be allocated to a floating namespace pool. For example, the namespace manager may determine that the remainder of the allocated capacity for each namespace that is not part of the guaranteed capacity value corresponds to a flexible capacity value that can be contributed to a floating namespace pool.

At block 1116, an aggregate capacity of the floating namespace pool may be determined. For example, the namespace manager may sum the flexible capacity value from each namespace contributing to the floating namespace pool to determine an aggregate capacity of the floating namespace pool.

At block 1118, storage operations may be processed for a target namespace among the set of namespaces. For example, a connected host system may send read, write, and/or other storage commands to the namespace in accordance with a storage protocol and those storage commands may be processed by the storage device in which that namespace is instantiated.

At block 1120, a filled mark may be determined for the target namespace. For example, after each storage operation is processed or on some other event or conditional basis, the namespace manager may update the operating parameters for the storage device and the namespaces it contains to track the memory locations and corresponding portion of the namespace capacity that is currently occupied by host data.

At block 1122, a flexible capacity threshold may be determined. For example, the namespace manager may be configured with one or more capacity thresholds for determining when a namespace should be allocated additional capacity, such as a buffer capacity value offset from the guaranteed capacity (a capacity threshold less than the guaranteed capacity) or a percentage of the flexible capacity that has been used (a capacity threshold greater than the guaranteed capacity).

At block 1124, the filled mark may be compared to the flexible capacity threshold. For example, the namespace manager may compare the current filled mark for the namespace to the corresponding flexible capacity threshold for that namespace.

At block 1126, the flexible capacity threshold may be determined to be met. For example, the current filled mark may equal or exceed the flexible capacity threshold,

At block 1128, capacity from the floating namespace pool may be allocated to the target namespace. For example, responsive to the flexible capacity threshold being met by the filled mark, the namespace manager may select a number of capacity units from the floating namespace pool for increasing the allocated capacity of the target namespace.

At block 1130, a guaranteed capacity value may be updated. For example, the namespace manager may increase the guaranteed capacity value equal to the new capacity units allocated to the target namespace and at least meet the current filled mark.

At block 1132, a flexible capacity value may be updated. For example, the namespace manager may change the flexible capacity value to be equal to the difference between the updated guaranteed capacity value and the updated allocated capacity for the namespace and, in some embodiments, may be maintained as a fixed flexible capacity or percentage of the allocated capacity.

At block 1134, aggregate capacity of the floating namespace pool may be decreased. For example, the namespace manager may decrease the remaining aggregate capacity of the floating namespace pool for the capacity units added to the target namespace. In some embodiments, the capacity units may be removed from the flexible capacity of another namespace in the set of namespaces and the flexible capacity of that namespace may also be updated.

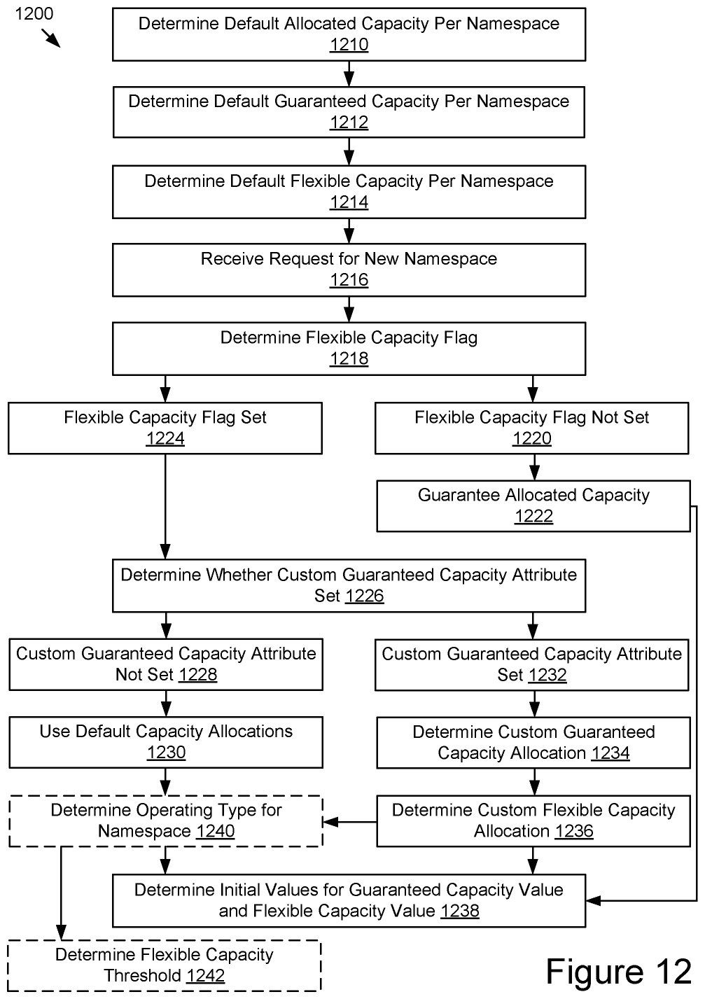

As shown in FIG. 12, storage node 500 may be operated according to an example method for configuring a namespace for use with the floating namespace pool, i.e., according to method 1200 illustrated by blocks 1210-1242 in FIG. 12.

At block 1210, a default allocated capacity per namespace may be determined. For example, the namespace manager may default to dividing the memory locations in a storage device evenly among the number of namespaces the storage device can support.

At block 1212, a default guaranteed capacity per namespace may be determined. For example, the namespace manager may be configured with a default guaranteed capacity, such as 50% of the allocated capacity of the namespace.

At block 1214, a default flexible capacity per namespace may be determined. For example, the namespace manager may be configured with a default flexible capacity that is the remainder of the allocated capacity of the namespace after the default guaranteed capacity, such as the other 50% of the allocated capacity of the namespace.

At block 1216, a request may be received for a new namespace. For example, the namespace manager may receive a namespace request to configure a new namespace on the storage device with the default allocated capacity or a requested capacity included as a parameter in the request.

At block 1218, a flexible capacity flag may be determined. For example, the namespace manager may check a parameter in the namespace request corresponding to the flexible capacity flag for enabling or disabling flexible capacity for the new namespace.

At block 1220, the flexible capacity flag is determined to not be set. For example, the namespace manager may find a 0 value in the flexible capacity flag.

At block 1222, the allocated capacity for the namespace may be guaranteed. For example, responsive to the flexible capacity flag value indicating that the namespace should not participate in the flexible capacity feature, the entire allocated capacity for the namespace may be treated as guaranteed capacity, i.e., the guaranteed capacity value equals the total allocated capacity of the namespace.

At block 1224, the flexible capacity value is determined to be set. For example, the namespace manager may find a 1 value in the flexible capacity flag.

At block 1226, whether a custom guaranteed capacity attribute is set may be determined. For example, the namespace manager may check a parameter in the namespace request corresponding to the custom guaranteed capacity attribute that allows user to define a custom guaranteed capacity value during the creation of a namespace.

At block 1228, the custom guaranteed capacity attribute may be determined not to be set. For example, the namespace manager may determine that the parameter in the namespace request is a null value, meaning that no custom guaranteed capacity value has been provided.

At block 1230, default capacity allocations may be used. For example, the namespace manager may use the default guaranteed capacity and default flexible capacity from blocks 1212 and 1214.

At block 1232, the custom guaranteed capacity attribute may be determined to be set. For example, the namespace manager may determine that the parameter in the namespace request is a valid custom value for determining a custom guaranteed capacity value.

At block 1234, a custom guaranteed capacity allocation may be determined. For example, the namespace manager may determine the custom guaranteed capacity allocation based on the custom guaranteed capacity attribute.

At block 1236, a custom flexible capacity allocation may be determined. For example, the namespace manager may determine the custom flexible capacity allocation based on the remainder of the allocated capacity after the custom guaranteed capacity allocation at block 1234.

At block 1238, initial values may be determined for the guaranteed capacity value and the flexible capacity value of the new namespace. For example, the namespace manager may use either the default capacity allocations or the custom capacity allocations to determine the initial values for the new namespace based on its allocated capacity.

In some embodiments, at block 1240, at least one operating type may be determined for the new namespace. For example, the namespace manager may determine read/write operating types or fast/slow filling operating types for the new namespace and the operating types may also be used to determine the initial values of the guaranteed capacity value and the flexible capacity value.

In some embodiments, at block 1242, a flexible capacity threshold may also be determined for the namespace. For example, the namespace manager may be configured with a default flexible capacity threshold, such as 50% of flexible capacity, or may dynamically determine the flexible capacity threshold based on one or more operating types determined at block 1240.

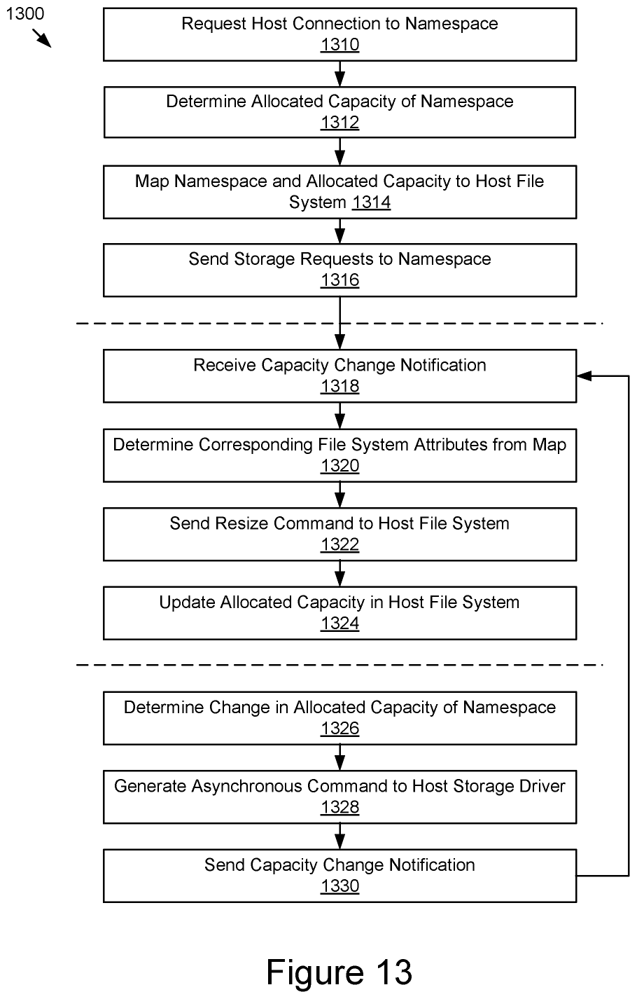

As shown in FIG. 13, storage node 500 may be operated according to an example method for managing namespace capacity changes at the host system, i.e., according to method 1300 illustrated by blocks 1310-1330 in FIG. 13. Note that blocks 1310-1324 may be executed by a host system and blocks 1326-1330 may be executed by a storage node or storage device.

At block 1310, a host connection to a namespace may be requested. For example, a host system may access a discovery log and send a connection request to a target storage node for a selected namespace.

At block 1312, the allocated capacity of the namespace may be determined. For example, the parameters of the namespace exposed to the host system may include an allocated capacity value for that namespace and the host system may determine the capacity of the namespace from that parameter.

At block 1314, the namespace and allocated capacity may be mapped to the host file system. For example, the host system may be configured for direct memory access to the namespace that allows the host system to treat the storage space as a local non-volatile memory resource within its file system and the file system may base a logical volume and/or other data units on the namespace and its allocated capacity.

At block 1316, storage requests may be sent to the namespace. For example, once the namespace is connected and configured as part of the file system, the host system may use a storage driver to send storage requests, such as read and write commands for host data, to the namespace and corresponding storage device for processing.

At block 1318, a capacity change notification may be received. For example, the storage driver of the host system may receive an interrupt command including a notification that the capacity of the namespace has changed.

At block 1320, corresponding file system attributes may be determined from a map. For example, the storage driver may include or access a mapping function or data structure that indicates how the namespace is mapped to one or more volumes or data units of the file system and extract the file system attributes for modifying the impacted volume(s).

At block 1322, a resize command may be sent to the host file system. For example, the storage driver may include a block layer filter that uses the file system attributes to generate a resize command to the file system for the impacted volume(s).

At block 1324, the allocated capacity in the host file system may be updated. For example, based on the resize command, the file system may resize the impacted volume(s) to reflect the change in allocated capacity of the namespace.

At block 1326, a change in allocated capacity of the namespace may be determined. For example, the namespace manager for the storage node or storage device may determine the change responsive to allocation of capacity units from a floating namespace pool as described above.

At block 1328, an asynchronous command to the host storage driver may be generated. For example, the namespace manager may generate an asynchronous command to the host storage driver that includes a capacity change notification parameter.

At block 1330, the capacity change notification may be sent to the host system. For example, the namespace manager may initiate a host interface to send the asynchronous command to the host system using the storage protocol.

While at least one exemplary embodiment has been presented in the foregoing detailed description of the technology, it should be appreciated that a vast number of variations may exist. It should also be appreciated that an exemplary embodiment or exemplary embodiments are examples, and are not intended to limit the scope, applicability, or configuration of the technology in any way. Rather, the foregoing detailed description will provide those skilled in the art with a convenient road map for implementing an exemplary embodiment of the technology, it being understood that various modifications may be made in a function and/or arrangement of elements described in an exemplary embodiment without departing from the scope of the technology, as set forth in the appended claims and their legal equivalents.

As will be appreciated by one of ordinary skill in the art, various aspects of the present technology may be embodied as a system, method, or computer program product. Accordingly, some aspects of the present technology may take the form of an entirely hardware embodiment, an entirely software embodiment (including firmware, resident software, micro-code, etc.), or a combination of hardware and software aspects that may all generally be referred to herein as a circuit, module, system, and/or network. Furthermore, various aspects of the present technology may take the form of a computer program product embodied in one or more computer-readable mediums including computer-readable program code embodied thereon.

Any combination of one or more computer-readable mediums may be utilized. A computer-readable medium may be a computer-readable signal medium or a physical computer-readable storage medium. A physical computer readable storage medium may be, for example, but not limited to, an electronic, magnetic, optical, crystal, polymer, electromagnetic, infrared, or semiconductor system, apparatus, or device, etc., or any suitable combination of the foregoing. Non-limiting examples of a physical computer-readable storage medium may include, but are not limited to, an electrical connection including one or more wires, a portable computer diskette, a hard disk, random access memory (RAM), read-only memory (ROM), an erasable programmable read-only memory (EPROM), an electrically erasable programmable read-only memory (EEPROM), a Flash memory, an optical fiber, a compact disk read-only memory (CD-ROM), an optical processor, a magnetic processor, etc., or any suitable combination of the foregoing. In the context of this document, a computer-readable storage medium may be any tangible medium that can contain or store a program or data for use by or in connection with an instruction execution system, apparatus, and/or device.

Computer code embodied on a computer-readable medium may be transmitted using any appropriate medium, including but not limited to, wireless, wired, optical fiber cable, radio frequency (RF), etc., or any suitable combination of the foregoing. Computer code for carrying out operations for aspects of the present technology may be written in any static language, such as the C programming language or other similar programming language. The computer code may execute entirely on a user's computing device, partly on a user's computing device, as a stand-alone software package, partly on a user's computing device and partly on a remote computing device, or entirely on the remote computing device or a server. In the latter scenario, a remote computing device may be connected to a user's computing device through any type of network, or communication system, including, but not limited to, a local area network (LAN) or a wide area network (WAN), Converged Network, or the connection may be made to an external computer (e.g., through the Internet using an Internet Service Provider).

Various aspects of the present technology may be described above with reference to flowchart illustrations and/or block diagrams of methods, apparatus, systems, and computer program products. It will be understood that each block of a flowchart illustration and/or a block diagram, and combinations of blocks in a flowchart illustration and/or block diagram, can be implemented by computer program instructions. These computer program instructions may be provided to a processing device (processor) of a general purpose computer, special purpose computer, or other programmable data processing apparatus to produce a machine, such that the instructions, which can execute via the processing device or other programmable data processing apparatus, create means for implementing the operations/acts specified in a flowchart and/or block(s) of a block diagram.

Some computer program instructions may also be stored in a computer-readable medium that can direct a computer, other programmable data processing apparatus, or other device(s) to operate in a particular manner, such that the instructions stored in a computer-readable medium to produce an article of manufacture including instructions that implement the operation/act specified in a flowchart and/or block(s) of a block diagram. Some computer program instructions may also be loaded onto a computing device, other programmable data processing apparatus, or other device(s) to cause a series of operational steps to be performed on the computing device, other programmable apparatus or other device(s) to produce a computer-implemented process such that the instructions executed by the computer or other programmable apparatus provide one or more processes for implementing the operation(s)/act(s) specified in a flowchart and/or block(s) of a block diagram.

A flowchart and/or block diagram in the above figures may illustrate an architecture, functionality, and/or operation of possible implementations of apparatus, systems, methods, and/or computer program products according to various aspects of the present technology. In this regard, a block in a flowchart or block diagram may represent a module, segment, or portion of code, which may comprise one or more executable instructions for implementing one or more specified logical functions. It should also be noted that, in some alternative aspects, some functions noted in a block may occur out of an order noted in the figures. For example, two blocks shown in succession may, in fact, be executed substantially concurrently, or blocks may at times be executed in a reverse order, depending upon the operations involved. It will also be noted that a block of a block diagram and/or flowchart illustration or a combination of blocks in a block diagram and/or flowchart illustration, can be implemented by special purpose hardware-based systems that may perform one or more specified operations or acts, or combinations of special purpose hardware and computer instructions.

While one or more aspects of the present technology have been illustrated and discussed in detail, one of ordinary skill in the art will appreciate that modifications and/or adaptations to the various aspects may be made without departing from the scope of the present technology, as set forth in the following claims.

1. A system, comprising:
a data storage device comprising:
a non-volatile storage medium configured to store host data for at least one host system; and
a host interface configured to communicate with the at least one host system using a storage protocol; and
a namespace manager configured to:
determine a plurality of host connections to a plurality of namespaces in the non-volatile storage medium, wherein:
each namespace of the plurality of namespaces has a first allocated capacity; and
at least one namespace of the plurality of namespaces allocates a portion of the first allocated capacity to a floating namespace pool;
determine, for a target namespace of the plurality of namespaces, whether a filled mark of the target namespace meets a flexible capacity threshold for the target namespace; and
allocate, responsive to the filled mark meeting the flexible capacity threshold, a capacity unit from the floating namespace pool to the target namespace to increase the first allocated capacity to a second allocated capacity.

2. The system of claim 1, wherein:
the first allocated capacity of each namespace of the plurality of namespaces comprises:
a guaranteed capacity value; and
a flexible capacity value; and
a sum of initial values for the guaranteed capacity value and the flexible capacity value equals the first allocated capacity.

3. The system of claim 2, wherein the namespace manager is further configured to:
receive a request for a new namespace in the plurality of namespaces;
determine, based on the first allocated capacity:
a default guaranteed capacity allocation; and
a default flexible capacity allocation; and
selectively determine, based on the default guaranteed capacity allocation and the default flexible capacity allocation, the initial values for the guaranteed capacity value and the flexible capacity value of the new namespace.

4. The system of claim 2, wherein the namespace manager is further configured to:
receive a request for a new namespace in the plurality of namespaces;
determine, from a custom guaranteed capacity attribute in the request:
a custom guaranteed capacity allocation; and
a custom flexible capacity allocation; and
selectively determine, based on the custom guaranteed capacity allocation and the custom flexible capacity allocation, the initial values for the guaranteed capacity value and the flexible capacity value of the new namespace.

5. The system of claim 2, wherein the namespace manager is further configured to:
receive a request for a new namespace in the plurality of namespaces;
determine, from the request, a flexible capacity flag; and
selectively determine, based on the flexible capacity flag and for the new namespace:
the guaranteed capacity value equals the first allocated capacity; and
the flexible capacity value equals zero.

6. The system of claim 2, wherein the namespace manager is further configured to:
determine, for each namespace of the plurality of namespaces, whether that namespace is an operating type selected from:
a fast filling namespace; or
a slow filling namespace; and
determine, based on the operating type for each namespace of the plurality of namespaces, the initial values for the guaranteed capacity value and the flexible capacity value for that namespace.

7. The system of claim 2, wherein the namespace manager is further configured to, responsive to allocating the capacity unit from the floating namespace pool:
update the guaranteed capacity value for the target namespace to the filled mark; and
update the flexible capacity value for the target namespace to a difference between the second allocated capacity and the updated guaranteed capacity value.

8. The system of claim 2, wherein the namespace manager is further configured to:
determine an aggregate capacity for the floating namespace pool based on the flexible capacity value of each namespace of the plurality of namespaces; and
decrease, responsive to allocating the capacity unit from the floating namespace pool, the aggregate capacity by the capacity unit.

9. The system of claim 2, wherein the floating namespace pool includes the flexible capacity value of each namespace in the plurality of namespaces and at least one unallocated capacity value from:
unallocated space from at least one non-volatile memory set defined using the storage protocol; or
unallocated space from at least one endurance group defined using the storage protocol.

10. The system of claim 1, further comprising:
the at least one the host system comprising:
a host processor;
a host memory;
a host file system;
a storage interface configured to communicate with the data storage device using the storage protocol; and
a storage driver configured to:
determine, for each namespace of the plurality of namespaces, the first allocated capacity;
map, for each namespace of the plurality of namespaces, the first allocated capacity to allocated capacity in the host file system;
receive a namespace capacity change notification for the target namespace, wherein the namespace manager is further configured to send the namespace capacity change notification responsive to allocating the capacity unit from the floating namespace pool; and
update the first allocated capacity to the second allocated capacity in the host file system.

11. A computer-implemented method, comprising:
determining a plurality of host connections to a plurality of namespaces in a non-volatile storage medium of a data storage device, wherein:
the plurality of host connections is configured for access from at least one host system to host data in the plurality of namespaces using a storage protocol; and
each namespace of the plurality of namespaces has a first allocated capacity;
allocating, for at least one namespace of the plurality of namespaces, a portion of the first allocated capacity to a floating namespace pool;
determining, for a target namespace of the plurality of namespaces, whether a filled mark of the target namespace meets a flexible capacity threshold for the target namespace; and
allocating, responsive to the filled mark meeting the flexible capacity threshold, a capacity unit from the floating namespace pool to the target namespace to increase the first allocated capacity to a second allocated capacity.

12. The computer-implemented method of claim 11, wherein:
the first allocated capacity of each namespace of the plurality of namespaces comprises:
a guaranteed capacity value; and
a flexible capacity value; and
a sum of initial values for the guaranteed capacity value and the flexible capacity value equals the first allocated capacity.

13. The computer-implemented method of claim 12, further comprising:
receiving a request for a new namespace in the plurality of namespaces;
determining, based on the first allocated capacity:
a default guaranteed capacity allocation; and
a default flexible capacity allocation; and
selectively determining, based on the default guaranteed capacity allocation and the default flexible capacity allocation, the initial values for the guaranteed capacity value and the flexible capacity value of the new namespace.

14. The computer-implemented method of claim 12, further comprising:
receiving a request for a new namespace in the plurality of namespaces;
determining, from a custom guaranteed capacity attribute in the request:
a custom guaranteed capacity allocation;
a custom flexible capacity allocation; and
selectively determining, based on the custom guaranteed capacity allocation and the custom flexible capacity allocation, the initial values for the guaranteed capacity value and the flexible capacity value of the new namespace.

15. The computer-implemented method of claim 12, further comprising:
receiving a request for a new namespace in the plurality of namespaces;
determining, from the request, a flexible capacity flag; and
selectively determining, based on the flexible capacity flag and for the new namespace:
the guaranteed capacity value equals the first allocated capacity; and
the flexible capacity value equals zero.

16. The computer-implemented method of claim 12, further comprising:
determining, for each namespace of the plurality of namespaces, whether that namespace is an operating type selected from:
a fast filling namespace; or
a slow filling namespace;
determining, based on the operating type for each namespace of the plurality of namespaces, the initial values for the guaranteed capacity value and the flexible capacity value for that namespace; and
determining, based on the operating type for each namespace of the plurality of namespaces, the flexible capacity threshold for that namespace.

17. The computer-implemented method of claim 12, further comprising, responsive to allocating the capacity unit from the floating namespace pool:
updating the guaranteed capacity value for the target namespace to the filled mark; and
updating the flexible capacity value for the target namespace to a difference between the second allocated capacity and the updated guaranteed capacity value.

18. The computer-implemented method of claim 12, further comprising:
determining an aggregate capacity for the floating namespace pool based on the flexible capacity value of each namespace of the plurality of namespaces; and
decreasing, responsive to allocating the capacity unit from the floating namespace pool, the aggregate capacity by the capacity unit.

19. The computer-implemented method of claim 18, further comprising:
determining, by the at least one host system and for each namespace of the plurality of namespaces, the first allocated capacity;
mapping, for each namespace of the plurality of namespaces, the first allocated capacity to allocated capacity in a host file system of the at least one host system;
sending, to the at least one host system, a namespace capacity change notification responsive to allocating the capacity unit from the floating namespace pool;
receiving, by the at least one host system, the namespace capacity change notification for the target namespace; and
updating, responsive to the namespace capacity change notification, the first allocated capacity to the second allocated capacity in the host file system.

20. A data storage device comprising:
a processor;
a memory;
a non-volatile storage medium configured to store host data for at least one host system;
a host interface configured to communicate with the at least one host system using a storage protocol;
means for determining a plurality of host connections to a plurality of namespaces in the non-volatile storage medium, wherein:
the plurality of host connections is configured for access from at least one host system to host data in the plurality of namespaces using a storage protocol; and
each namespace of the plurality of namespaces has a first allocated capacity;
means for allocating, for at least one namespace of the plurality of namespaces, a portion of the first allocated capacity to a floating namespace pool;
means for determining, for a target namespace of the plurality of namespaces, whether a filled mark of the target namespace meets a flexible capacity threshold for the target namespace; and
means for allocating, responsive to the filled mark meeting the flexible capacity threshold, a capacity unit from the floating namespace pool to the target namespace to increase the first allocated capacity to a second allocated capacity.
